(19) United States
(12) Patent Application Publication
(10) Pub. No.: US 2015/0020151 A1
(43) Pub. Date: Jan. 15, 2015

(54) SYSTEMS AND METHODS FOR TRUSTED SHARING

(71) Applicant: ContentRaven, LLC, Marlborough, MA (US)

(72) Inventor: Vasudevan Ramanathan, South Grafton, MA (US)

(21) Appl. No.: 14/325,839

(22) Filed: Jul. 8, 2014

Related U.S. Application Data
(60) Provisional application No. 61/844,220, filed on Jul. 9, 2013.

(51) Int. Cl. G06F 21/62; H04L 29/06

(52) U.S. Cl. CPC G06F 21/6218; H04L 63/20
USPC 726/1

(57) ABSTRACT

A content distribution system for controlling access of digital content that is shared with indirect contacts receives from a publisher of digital content, a specification of a sharing policy for sharing by a first user to indirect contacts to be identified at the time of distribution. The sharing policy can identify a number of shares, a number of indirect contacts, acceptable web domains, or acceptable geographic regions. The system receives a request from the first user to access the content. The first user is a contact of the publisher identified by the publisher. The system authorizes the first user to access the content and receives from the first user a request to share the content with a second user that is a contact of the first user and an indirect contact of the publisher. The system authorizes, in accordance with the sharing policy, the second user to access the content.

### RELATED APPLICATION

This application claims priority to U.S. Provisional Patent Application 61/844,220, entitled “Systems and Methods for Trusted Sharing,” filed Jul. 9, 2013, the disclosure of which is incorporated by reference herein in its entirety.

### FIELD OF THE DISCLOSURE

The present application relates generally to digital content distribution and, more particularly, to methods and systems for managing user access to and use of published content that is shared virally to indirect contacts.

### BACKGROUND

The pervasive use of social networking and mobile phones has made the distribution of content between people effortless. As a result, controlling the access of content from being shared virally with unintended recipients has become harder. Existing content distribution methods do not allow for content to be shared with a large number of recipients, some of whom may be unknown to the content publisher, while maintaining control over the content.

### SUMMARY

The present disclosure relates to methods and systems for controlling access of digital content that is shared with indirect contacts. In one aspect, a content distribution system receives from a publisher of digital content, a specification of a sharing policy for sharing by a first user to one or more indirect contacts to be identified at the time of distribution. In some implementations, the sharing policy identifies a number of shares, a number of indirect contacts, one or more acceptable web domains, or one or more acceptable geographic regions. The content distribution system receives a request from the first user to access the digital content. The first user is a contact of the publisher identified by the publisher. The content distribution system authorizes the first user to access the digital content and receives from the first user a request to share the digital content with a second user that is a contact of the first user and an indirect contact of the publisher. The content distribution system then authorizes, in accordance with the sharing policy, the second user to access the digital content.

In one aspect, a method for sharing digital content via the content distribution system while maintaining control over access to the digital content. A content distribution system having one or more processors receives, from a publisher of digital content, configuration of a sharing policy for sharing the digital content. The content distribution system receives a first request of a first user to access the digital content. The content distribution system provides access to the first user, to the digital content. The content distribution system receives a second request of the first user to share the digital content with a second user. The content distribution system determines based on the sharing policy, that the first user is authorized to share the digital content with the second user and responsive to the determination, provides access to the second user to the digital content.

In some implementations, the publisher can specify the identity of a specific user to receive access to the digital content via the content distribution system and a predetermined number of devices for the specific user. In some implementations, the publisher can specify a geographical limitation on a location at which devices of the predetermined number of devices are authorized to access the digital content. In some implementations, the publisher can specify a dynamic expiration of when devices of the predetermined number of devices are authorized to access the digital content. The dynamic expiration includes one of a given number of days or a scheduled date upon which the digital content is no longer accessible without further action by the publisher.

In some implementations, the content distribution system can receive the first request responsive to the first user receiving a communication that the digital content is available at the content distribution system. In some implementations, the content distribution system identifies that a device associated with the first user has not been assigned a unique device identifier generated by the content distribution system. In some implementations, the content distribution system can identify that a number of unique device identifiers generated for the digital content has reached a same number as the predetermined number of devices. In some implementations, the content distribution system can deny the second user access to the digital content responsive to identifying that the number of unique device identifiers generated for the digital content has reached a same number as the predetermined number of devices.

In some implementations, the content distribution system can receive a third request of a device to access the digital content. The device may have been previously activated by the content distribution system as one of a predetermined number of devices authorized to access the digital content. The content distribution system can provide access to the device to the digital content.

In some implementations, the content distribution system can receive a third request from a device to access the digital content. The content distribution system then determines that one of a geographical location of the device or time of access by the device does not meet a policy specified by the publisher for the digital content and restricts the device from accessing the digital content.

In another aspect, a system for sharing digital content while maintaining control over access to the digital content is described. The system includes a content distribution system including a memory and one or more processors. The content distribution system includes a policy engine configured to receive configuration of a sharing policy for sharing digital content. The content distribution system also includes a digital content manager configured to receive a first request of a first user to access the digital content. The digital content manager is configured to provide access to the first user, to the digital content. The digital content manager is configured to receive a second request of the first user to share the digital content with a second user. The digital content manager is configured to determine, based on the sharing policy, that the first user is authorized to share the digital content with the second user and responsive to the determination, provide access to the second user to the digital content.

In some implementations, the publisher can specify the identity of a specific user to receive access to the digital content via the content distribution system and a predetermined number of devices for the specific user. In some implementations, the publisher can specify a geographical limitation on a location at which devices of the predetermined number of devices are authorized to access the digital content. In some implementations, the publisher can specify a dynamic expiration of when devices of the predetermined number of devices are authorized to access the digital content. The dynamic expiration includes one of a given number of days or a scheduled date upon which the digital content is no longer accessible without further action by the publisher.

In some implementations, the digital content manager can receive the first request responsive to the first user receiving a communication that the digital content is available at the content distribution system. In some implementations, the digital content manager identifies that a device associated with the first user has not been assigned a unique device identifier generated by the content distribution system. In some implementations, the digital content manager can identify that a number of unique device identifiers generated for the digital content has reached a same number as the predetermined number of devices. In some implementations, the digital content manager can deny the second user access to the digital content responsive to identifying that the number of unique device identifiers generated for the digital content has reached a same number as the predetermined number of devices.

In some implementations, the digital content manager can receive a third request of a device to access the digital content. The device may have been previously activated by the digital content manager as one of a predetermined number of devices authorized to access the digital content. The digital content manager can provide access to the device to the digital content.

In some implementations, the digital content manager can receive a third request from a device to access the digital content. The digital content manager then determines that one of a geographical location of the device or time of access by the device does not meet a policy specified by the publisher for the digital content and restricts the device from accessing the digital content.

According to another aspect, a method for controlling access of digital content that is shared with indirect contacts is disclosed. A content distribution system receives from a publisher of digital content, a specification of a sharing policy for sharing by a first user to one or more indirect contacts to be identified at the time of distribution. In some implementations, the sharing policy identifies a number of shares, a number of indirect contacts, one or more acceptable web domains, or one or more acceptable geographic regions. The content distribution system receives a request from the first user to access the digital content. The first user is a contact of the publisher identified by the publisher. The content distribution system authorizes the first user to access the digital content and receives from the first user a request to share the digital content with a second user that is a contact of the first user and an indirect contact of the publisher. The content distribution system then authorizes, in accordance with the sharing policy, the second user to access the digital content.

In some implementations, the publisher can specify the identity of a specific user to receive access to the digital content via the content distribution system and the predetermined number of devices for the specific user. In some implementations, the publisher can specify a geographical limitation on a location at which devices of the predetermined number of devices is authorized to access the digital content. In some implementations, the publisher can specify a dynamic expiration of when devices of the predetermined number of devices is authorized to access the digital content. The dynamic expiration includes one of a given number of days or a scheduled date upon which the digital content is no longer accessible without further action by the publisher.

In some implementations, the content distribution system can receive the request from a user of the device in response to the user receiving a communication that the digital content is available at the content distribution system. In some implementations, the content distribution system identifies that the device has not been assigned a unique device identifier generated by the content distribution system. In some implementations, the content distribution system can identify that a number of unique device identifiers generated for the digital content has reached a same number as the predetermined number of devices.

In some implementations, the content distribution system can deny the second device access to the content distribution system. In some implementations, the content distribution system can receive a second request from a second device to access the digital content. The second device may have been previously activated by the content distribution system as one of the predetermined number of devices. The content distribution system can provide access to the digital content to the second device.

In some implementations, the content distribution system can receive a second request from a second device to access the digital content. The content distribution system then determines that one of a geographical location of the second device or time of access by the second device does not meet a policy specified by the publisher for the digital content and restricts the second device from accessing the digital content.

### BRIEF DESCRIPTION OF THE DRAWINGS

FIG. 1A is a block diagram depicting an embodiment of a network environment comprising local devices in communication with remote devices.

FIGS. 1B-1D are block diagrams depicting embodiments of computers useful in connection with the methods and systems described herein.

FIG. 2A is a block diagram illustrating a computer networked environment for securely distributing digital content in accordance with various embodiments.

FIG. 2B illustrates a screenshot of a secure portal through which content publishers can quickly and easily revoke access to published content in accordance with one or more embodiments.

FIG. 2C illustrates a screenshot of a secure portal through which content publishers can dynamically expire content in accordance with one or more embodiments.

FIG. 2D illustrates a screenshot of a secure portal through which content publishers can publish additional relevant content back to end-users in response to analytical reporting in accordance with one or more embodiments.

FIG. 3 is a block diagram of an embodiment of a system for secure digital content distribution and analytical reporting.

FIG. 4 is a flow diagram of an embodiment of a method for using the content distribution system.

FIG. 5 is a block diagram of a system for secure digital content distribution in accordance with one or more sharing policies.

FIG. 6 is an embodiment of a method of sharing digital content via the content distribution system while maintaining control over access to the digital content.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein.

Section B describes embodiments of systems and methods for securely distributing digital content and analytical reporting.

Section C describes embodiments of systems and methods for controlling access of digital content that is shared with indirect contacts.

A. Computing and Network Environment

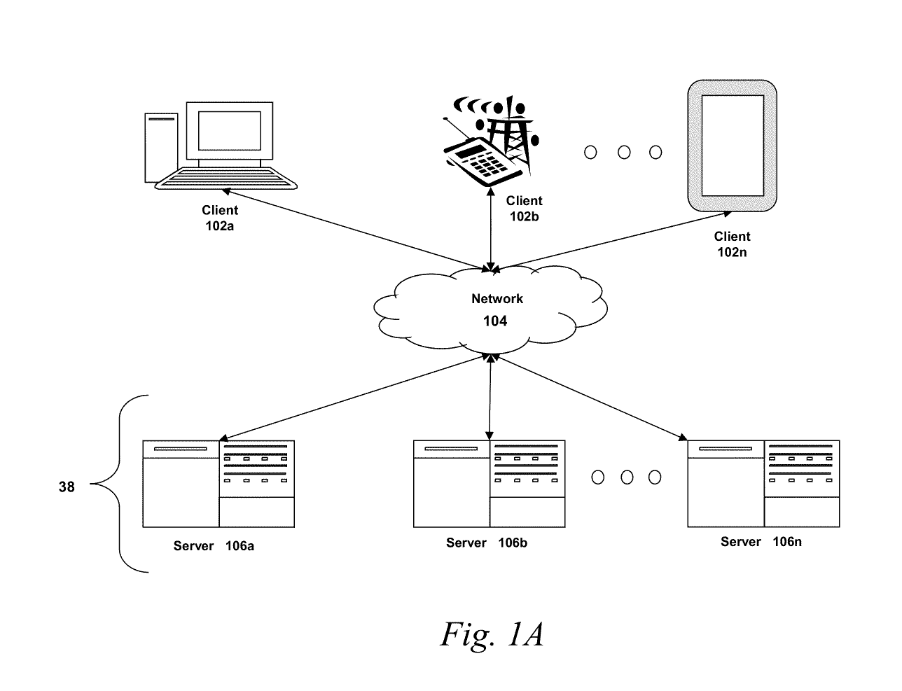

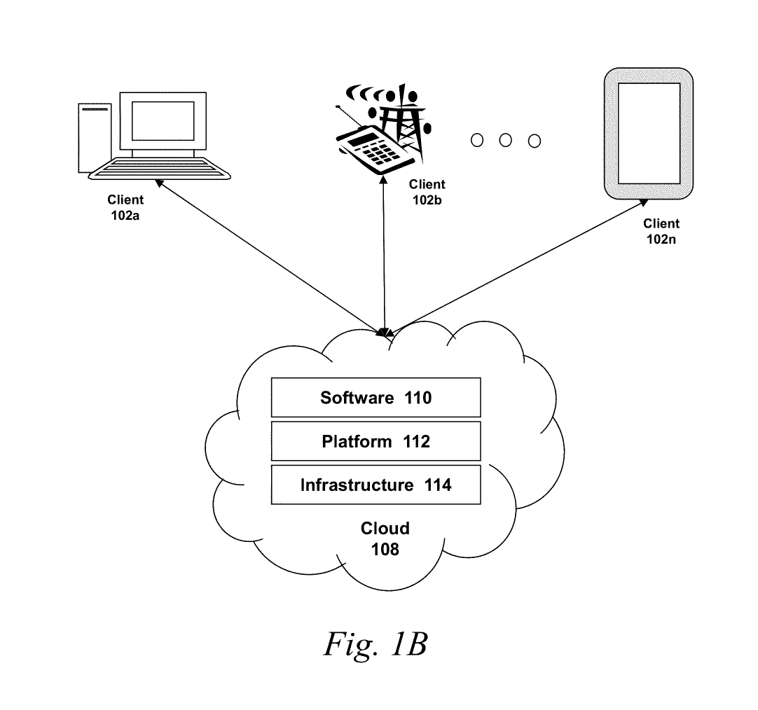

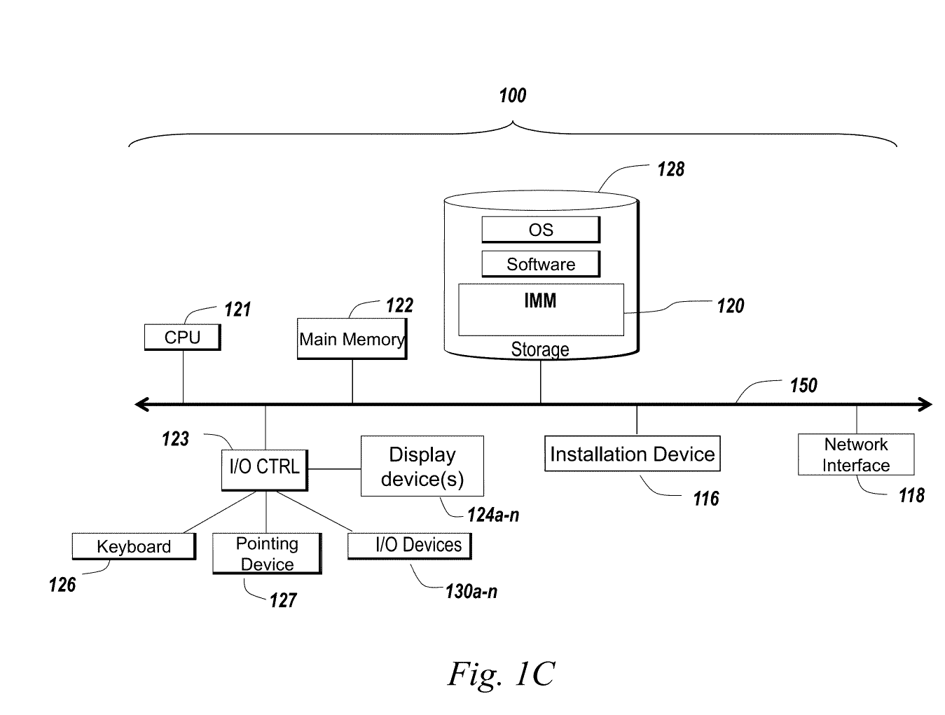

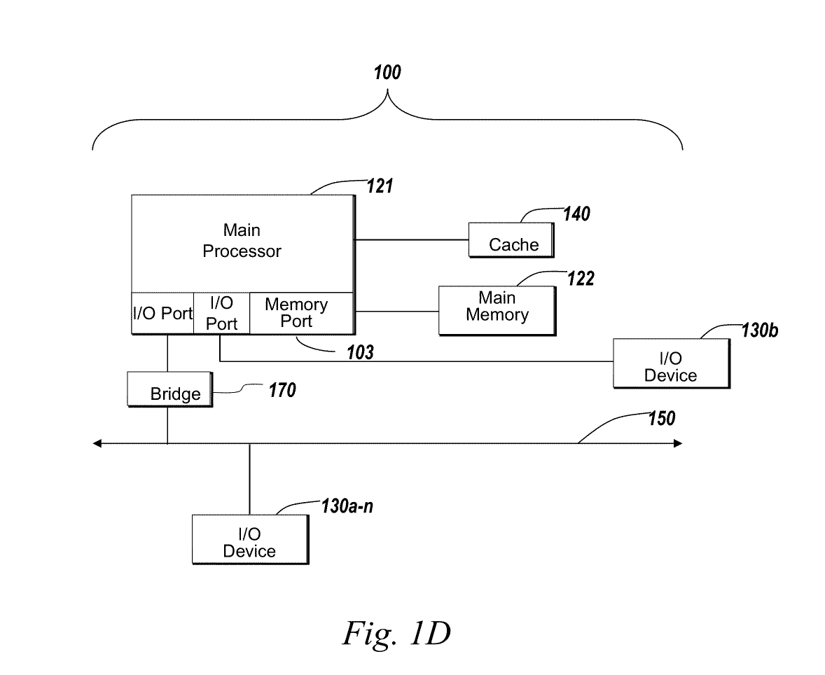

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a software of a content distribution system (CDS) 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120 for the content distribution system. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is a eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

B. Systems and Methods of a Content Distribution System

Various embodiments disclosed herein are directed to a digital content distribution system that allows a content publisher to securely distribute content to end-users and manage policies on how that content is consumed. The content distribution system is cloud-based and publishes secured content through the Internet. The system also provides analytical reports, which provide content publishers with insight into, e.g., who is accessing content files, how often, and from where.

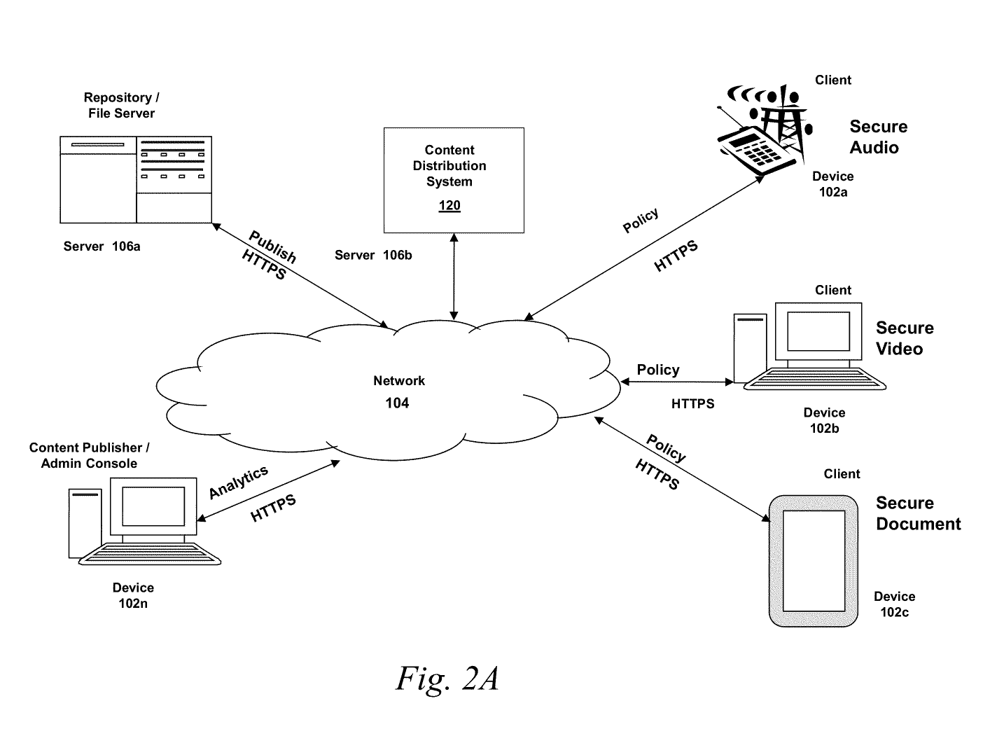

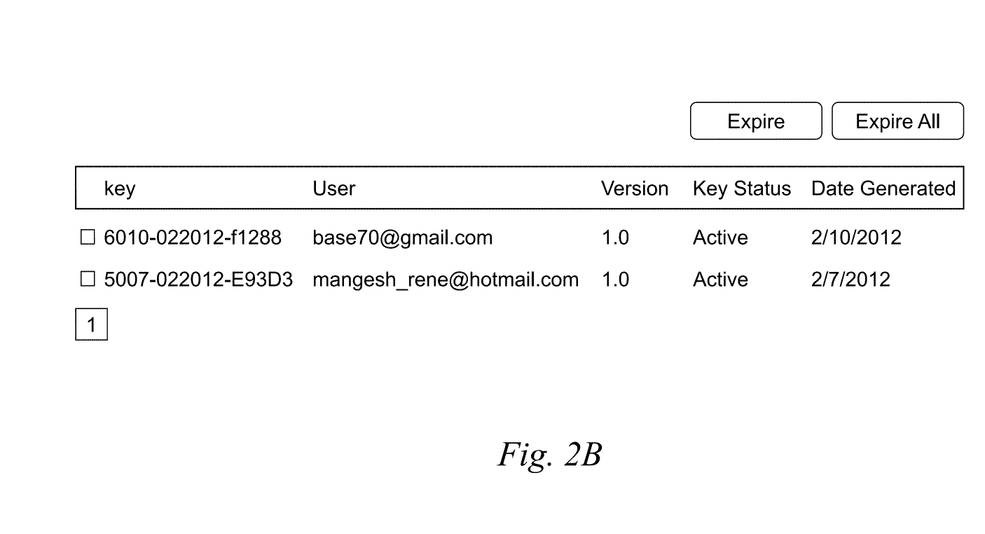

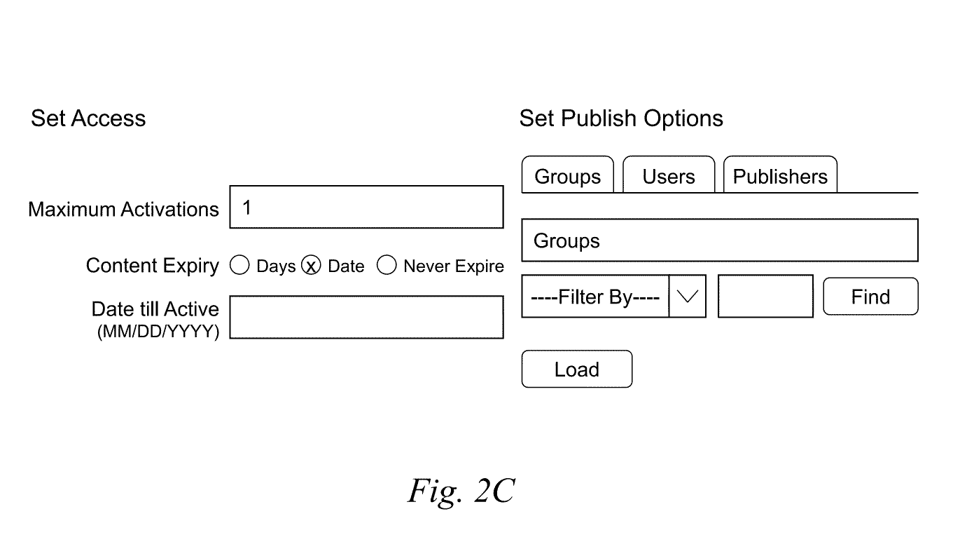

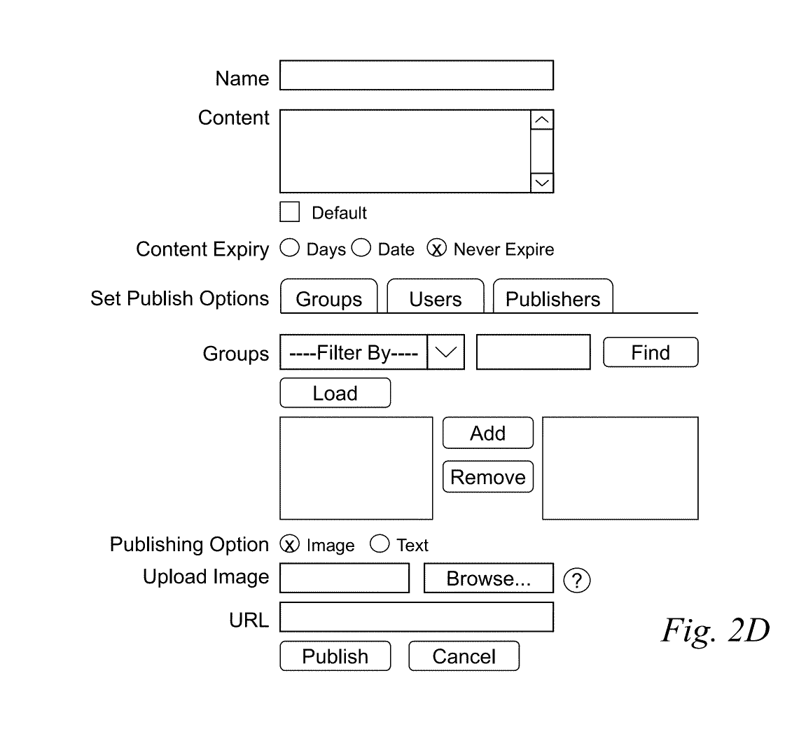

FIG. 2A is a simplified diagram illustrating operation of a content distribution system in accordance with various embodiments. As shown in FIG. 2A, the content distribution system 120 is configured to allow a content publisher to securely distribute digital content to end users or clients over a network, such as the network 104. In addition, the content distribution system 120 is configured to allow the content publisher to manage policies on how that digital content is consumed. In operation, the content distribution system can receive a request from the content publisher 106 to securely distribute content to one or more clients. The request can include the content to be distributed or can include information identifying the content to be distributed. In some embodiments, the request can include information indicating where the content is stored. In some embodiments, the content is stored in a repository, which is located at a remote location but accessible via the network 104. In some embodiments, the content is stored locally with the content publisher. In some embodiments, the content is stored in a server associated with the content distribution system. In addition, the request can include one or more rules or policies associated with the content to be distributed. A content publisher initially uploads content to be distributed to the content delivery system. Rules set by the content publisher control who can access the content and what they can do with it (e.g., save, copy to a USB device, print, or forward to others).

Upon receiving the request from the content publisher, the content distribution system processes the request. In some embodiments, the content distribution system identifies the content and utilizes the rules set by the content publisher to generate one or more notifications, which the content distribution system provides to the intended recipients indicating that they have received new content. In some embodiments, the content distribution system sends the notification to the intended recipients via email. In some embodiments, the content distribution system can identify the intended recipient and responsive to identifying the intended recipient, sends a notification to a native application installed on a device associated with the intended recipient.

The intended recipient receives the notification indicating that they have received new content via the content distribution system. The intended recipient is prompted to enter identifying information, for example, a user login and password. After the user's credentials have been verified, the user is directed to a secure portal on the content distribution system where the digital content is made accessible to the intended recipient. In some embodiments, the digital content can be viewed by the user through a web browser on the intended recipient's device. In some embodiments, the intended recipient may be able to access the digital content without having to install an application, web applet or any other type of software.

In some embodiments, the content distribution system 120 is configured to allow content publishers to restrict the number of client devices from which a user can access the published digital content. For instance, if a policy restricts access to digital content to one device for a user, the user will not be able to access that digital content on a different device.

In some embodiments, the digital content is stored locally within the content distribution system 120. In some implementations, the portal can store a library of content accessible to the intended recipient. In some other embodiments, the digital content is only accessed by the content distribution system but not stored by the content distribution system. In some embodiments, the digital content is encrypted and rendered on the content distribution system with no temporary files created locally on the intended recipient's device when the content is accessed online.

The digital content can be any type of digital content that is capable of being accessed by the intended recipient. Stated in another way, the digital content can be in virtually any format. Examples of the types of digital content can include audio content, video content, multimedia content, text, including content in any of a PDF, Flash, Microsoft Office Suite, and HTML format, among others.

In some embodiments, the content distribution system 120 determines the type of digital content. Responsive to determining the type of digital content, the content distribution system 120 can select one of a plurality of formats in which the digital content is to be presented. In some embodiments, the digital content can be a document, such as a PDF, Microsoft Office document, an image, amongst others. The content distribution system may converts, translate or transform digital content to be distributed into a single or common format for distribution, such as an image format (jpeg, bitmap, etc.). In some embodiments, the content distribution system can be configured to allow the intended recipient to only access or view one page of the document at a time. In some embodiments, the digital content can be an audio file or stream, a video file or stream or a multimedia file or stream. In some such embodiments, the content distribution system can be configured to allow the intended recipient to access the audio stream, video stream or multimedia stream. In some such embodiments, one or more functions associated with the audio stream, video stream or multimedia stream can be disabled. For instance, the content distribution system can disable the PAUSE or STOP function. In this way, the content distribution system can control how the audio stream, video stream or multimedia stream is being displayed. This may be beneficial in situations where the content publisher would like the intended recipient to only access or view the audio stream, video stream or multimedia stream once or in one continuous sitting without any interruptions.

In some implementations, the content distribution system 120 can add a watermark or other security feature on the digital content made accessible to the intended recipient. The watermark or other security feature can include or correspond to information that identifies the intended recipient. In this way, if the intended recipient attempts to reproduce the media content made accessible to the intended recipient, for example, by taking a photo image or screen capture image of a screen displaying the content, the reproduced media content will include the watermark or other security feature. These security measures can inhibit unauthorized distribution of the content. In some embodiments in which the digital content includes an audio stream, an audio-based security feature can be added to the audio stream either continuously or periodically to inhibit unauthorized distribution of the content.

Because the digital content is made accessible to the intended recipient by the content distribution system 120 without allowing the digital content to be stored on the user's client device, the content distribution system 120 can be configured to allow the content publisher publishing the content to easily revoke the intended recipient's access to the digital content. In addition, the content publisher can also update or modify the content while minimizing the possibility that prior versions of the content are being distributed without the knowledge of the content publisher. Moreover, the content publisher can effectively manage access to the digital content in real-time or on-demand. For instance, the content publisher can remotely terminate access to previously published content or content currently accessible to intended recipients. In some embodiments, the content publisher may wish to terminate access for any reason. For example, the content publisher may elect to terminate access to reports that include outdated content or content that has been corrupted or inappropriately accessed.

FIG. 2B illustrates a screenshot of a secure portal through which content publishers can quickly and easily revoke access to published content in accordance with one or more embodiments. In some embodiments, the content publisher can revoke access to previously published content in a “1-click” operation. Specifically, to revoke access, the content publisher simply clicks the “Expire All” button or the “Expire” button after selecting end-users whose rights are to be revoked.

FIG. 2C illustrates a screenshot of a secure portal through which content publishers can dynamically expire content in accordance with one or more embodiments. In some embodiments, the content distribution system 120 can be configured to dynamically grant and revoke the intended recipient's ability to access the digital content. As shown in FIG. 2C, the content publisher can dynamically schedule an expiration of the intended recipient's ability to access the digital content. In some embodiments, the content publisher can cause the digital content to become inaccessible by specific intended recipients that were previously granted access to the digital content. In some such embodiments, the content distribution system can set an expiration time on the intended recipient's ability to access the digital content. For example, the content distribution system 120 can set an expiration time based on a calendar date or based on a predetermined time period from the time the notification was sent to the intended recipient or from the time the intended recipient first accessed the content. In some implementations, the expiration can be based on a number of times the intended recipient accesses the digital content. In some implementations, the expiration can be based on a number of times the digital content has been accessed, regardless of which intended recipients accessed the digital content. In some embodiments, the expiration can be based on a number of times the digital content has been accessed by unique intended recipients. In some embodiments, the expiration of the digital content can be broken down into the expiration of different portions of the digital content. For example, if the digital content includes a reading assignment for school children, a teacher may wish to only allow the intended recipients (or children in this example) to view only a first portion of the reading assignment during the first week, while allowing the children to view only a second portion of the reading assignment during the second week and so forth. In this way, the teacher can provide the digital content to the children once while being able to restrict access to different portions of the digital content according to the teacher's schedule. It should be appreciated that by setting these expiration conditions on the digital content, the digital content is no longer accessible to the one or more intended recipients without requiring the content publisher to take an active step at the time of expiration. In some embodiments, the expiration can be set at generally any time, including but not limited to when the content is initially uploaded to the content distribution system.

As the content distribution system 120 controls the distribution of the digital content to the intended recipients, the content distribution system 120 is able to analyze the usage of the digital content by the intended recipients. In particular, as described above, the content distribution system is capable of providing the intended recipient's access to the digital content, for example, documents, one page at a time, the content distribution system can track how many times each page of the digital content has been accessed, for how long the page has been accessed, the identity of the intended user accessing the digital content as well as the type of device the intended recipient uses to access the digital content, amongst others. For instance, the content distribution system can track the location from where the intended recipient accesses the digital content as well as the associated time and date information. In some embodiments, the content distribution system can generate analytical reports for content publishers on usage of their content by the intended recipients. In some embodiments, the reports can be down to the page level. This allows content publishers to track and understand how the content is being used, the devices on which it is viewed, and the geographic locations of users.

FIG. 2D illustrates a screenshot of a secure portal through which content publishers can publish additional relevant content back to end-users in response to analytical reporting in accordance with one or more embodiments. Based on usage analytics, content publishers can publish additional relevant content back to the user. The relevant content can be time sensitive and can be published to a specific user or to selected groups of users as shown, by way of example, in the screenshot shown in FIG. 2D.

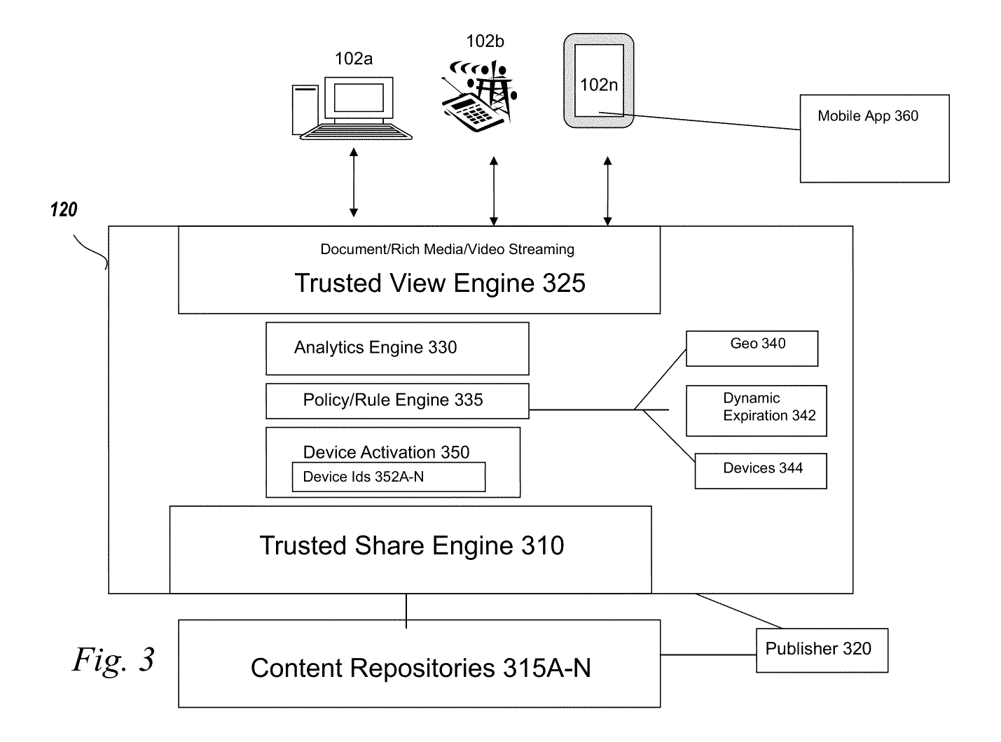

FIG. 3 is a block diagram of an embodiment of a system for secure digital content distribution and analytical reporting. The content distribution system 120 may execute on one or more servers and may be in communication over a network with one or more clients 102a-102n. The content distribution system allows a content publisher 320 to securely distribute, share or provide access to one or more users digital content that may be stored in one or more content repositories 315. In some embodiments, the client devices 102 can communicate with the content distribution system 120 via a web browser or an application, such as a mobile application 360, that is installed on the user device.

The content distribution system, and any modules or components thereof, may comprise one or more applications, programs, libraries, services, processes, scripts, tasks or any type and form of executable instructions executing on one or more devices, such as servers. The content distribution system, and any modules or components thereof, may use any type and form of database for storage and retrieval of data. The content distribution system may comprise function, logic and operations to perform any of the methods described herein.

The content repositories 315 may include any type and form of storage or storage service for storing data such as digital content. The content distribution system may be designed, constructed and/or configured to communicate with and/or interface to a plurality of different content repositories. In some embodiments, the content distribution communicate with the content repositories over one or more networks 104, such as to a remote server or cloud storage service. In some embodiments, the content repositories 315 may be located in a network separate from the network of the content distribution system, such as in the cloud. Examples of such content repositories 315 include servers or services provided by Dropbox, Box.com, Google, amongst others. In some embodiments, the content repositories 315 are maintained by a content publisher 320. In some embodiments, the content repositories are located local to the content publisher 320.

The content distribution system 120 may include a trusted share engine 310, a trusted view engine 325, an analytics engine 330, a policy/rule engine 335, and a device activation engine 350. The trusted share engine provides an interface for publisher to identify content via content repositories to distribute via the content distribution system. The trusted view engine may provide an interface to the publisher to specify rules of policies via the policy/rule engine 335. The trusted view engine may provide an interface to the publisher to the analytics engine to access and view usage data about the digital content. The device activation engine may activate, control and manage the devices that access the digital content via the content distribution system.

The trusted share engine 310 is designed, constructed and/or configured to allow a publisher to identify, distribute and control the distribution and access of digital content via the content distribution system. The trusted share engine may communicate with a device of the content publisher 320 and any of the devices of the content repositories 315. The trusted share engine of the content distribution system may provide an interface for a publisher to identify and configure digital content to be shared in a trusted manner via the content distribution system. In some embodiments, the trusted share engine 310 provides a user interface to the content publisher through which the content publisher 320 can submit one or more requests to securely distribute digital content. A request can identify digital content to be distributed and controlled via the content distribution system. The content publisher may identify a remote storage location of the digital content to the content distribution system, such as a uniform resource locator or file name to the digital content stored in or at a cloud storage system or device, such as a server, for example, one of the content repositories 315, remote to the content distribution system. In some embodiments, the content publisher may upload the digital content to a storage location of the content distribution system via the trusted share engine. In some embodiments, the publisher may upload the digital content to a remote storage location identified, specified or provided by the content distribution system. In some embodiments, the trusted share engine can allow the publisher to configure a title, description, publisher/owner or source and remote storage location of the digital content.

The request from the content publisher can also include one or more policies or rules restricting access to the digital content. In some embodiments, the trusted share engine can allow the publisher to specify or configure one or more rules of policies to apply to the digital content. In some embodiments, the publisher may, via the trusted share engine, specify or configure rules and policies on a per digital content basis, such that different digital content (e.g., one document or file versus a different document or file) may have different rules and/or policies. The publisher may, via the trusted share engine, specify or configure rules and policies on a group or set of digital content, such that the digital content assigned to or part of a group or set have the same rules and/or policies.

In some embodiments, the trusted share engine allows the publisher to identify the names or identities of specific or group of users who may access the digital content via the content distribution system, such as by email address or by user name within the content distribution system. In some embodiments, the trusted share engine can allow the publisher to configure a rule of a policy to specify a predetermined number of device from which a specific or particular user may access the digital content via the content distribution system. The publisher may, via the trusted share engine, configure a rule of a policy to specify a predetermined number of devices from which any user may access the digital content. The publisher may, via the trusted share engine, configure a rule of a policy to specify a type of device (such as desktop/laptop versus mobile, tablets or smartphone) for each of the predetermined number of devices. The publisher may configure a rule of a policy to specify a geographic location in which a device must be located to access the digital content via the trusted share engine. The geographic location may be specified or configured at any breadth or granularity, such as by continent, country, region, state or city. In some embodiments, the request can specify that only devices located within a particular premises, for example, a company's office space, can access the digital content.

In some embodiments, the trusted share engine allows a publisher to configure via the policy/rule engine a rule of a policy to specify temporal conditions or constraints on accessing the digital content via the trusted share engine. The publisher may configure a rule of a policy to specify a time of day during which the digital content may be accessed. The publisher may configure a rule of a policy to specify an amount of time for which the digital content may be accessed by a user or device. The publisher may configure a rule of a policy to specify dynamic expiration of the digital content such as by a predetermined number of days or scheduled date. In some other embodiments, the expiration can be based on a number of times a particular user accesses the digital content. In some implementations, the expiration can be based on a number of times the digital content has been accessed, regardless of which users accessed the digital content. In some embodiments, the expiration can be based on a number of times the digital content has been accessed by unique users and/or user devices.

The trusted view engine 325 is designed, constructed and configured to communicate the availability of the digital content via the content distribution system to one or more end users. The trusted view engine may provide an interface for sending communications to users. In some embodiments, the trusted view engine 325 sends an electronic communication to one or more users at their corresponding contact information. In some embodiments, the trusted view engine 325 transmits an email to a corresponding email address of a user or a text (e.g., SMS or MMS) message to a user at a corresponding number. In some embodiments, the trusted view engine can submit or post a message to a web-site, such as a social networking site. The trusted view engine may submit or post a message to a page of a user at a social networking site. The trusted view engine can submit or post a message to an account of a user within the content distribution system. The trusted view engine may provide a notification via a mobile application on a mobile device of a user.

The trusted view engine 325 may receive a request from a device to access the digital content. In some embodiments, the trusted view engine receives from a browser operating on a user device or via a mobile application communicating with the with the server of the content distribution system. In some embodiments, the trusted view engine may receive the request from a device not yet identified or known by the content distribution system. In some embodiments, the trusted view engine may receive the request from a device not yet activated or authorized by the content distribution system. In some embodiments, the trusted view engine may receive the request from a device previously activated or authorized by the content distribution system. In some embodiments, the trusted view engine may receive the request from a device previously identified or known by the content distribution system. In some embodiments, the trusted view engine may receive the request from a device associated with or allocated to usage with the digital content or otherwise allocated to one of the predetermined number of devices.

In some embodiments, the trusted view engine 325 can identify or determine if the device from which the request is received is activated and/or authorized to access the digital content according to the rules and policies set by the content publisher. In some embodiments, the trusted view engine 325 can identify that the device requesting to access the digital content has not been previously activated by the content distribution system by receiving a device identifier associated with the device requesting to access the digital content and comparing the device identifier with a list of device identifiers of previously activated devices. In some embodiments, this list is maintained by the content distribution system 120. In some embodiments, the device identifier can be any type and form of software construct, key, random number generated by the content distribution system 120 that has been previously provided to the device. In some embodiments, the device identifier is a universal user device identifier of the user device, such as an IMEI number of a mobile device or a MAC address of a network component of the device.

In some embodiments, the trusted view engine 325 identifies that the device requesting to access the digital content has not been previously activated by the content distribution system. In some embodiments, the trusted view engine 325 may determine that the user requesting access to the digital content has not previously accessed digital content via the content distribution system, the trusted view engine 325 may provide an interface through which the user can register. In some embodiments, the trusted view engine 325 may register a user and the device through which the user is requesting access to the digital content. Upon registering the user, the trusted view engine 325 may provide the user device with a device identifier through which the user device can be identified.

In some embodiments, the trusted view engine 325 prompts the user to provide security credentials, such as a user identification and password. If the device and/or user is authorized/granted via user authentication and/or via application of any policies applicable to the digital content, the trusted view engine 325 provides access to the digital content to the device in a content secure manner, such a via streaming a page by page view. In the case of a browser, the device may receive access in a secure manner to the digital content within a browser. The trusted view engine 325 may provide a widget, script, applet, application or other type and form of executable instructions executing within the memory of the browser to provide, display and control the display and access to the digital content in a secure manner. The widget, script, applet, application or other type and form of executable instructions may be automatically and/or silently installed or included with the serving of the web page such that the end user does not need to install any client-side application to use the content distribution system. Likewise, for a mobile application access to the content distribution system, the mobile application may be designed and constructed to provide, display and control display and access to the digital content in a secure manner.

In delivering digital content from the content repositories, the content distribution system may communicate or stream the digital content from the content repositories to the end user's device via the content distribution system in a secure manner. The content distribution system may communicate or stream the digital content from the content repositories to the end user's device using symmetric stream ciphers. In some embodiments, the content distribution system may communicate or stream the digital content from the content distribution system to the end user's device in a secure manner, such as using symmetric stream ciphers. The content distribution system, via a content distribution manager, may automatically manage and handle the exchange of keys and authentication between the content distribution system and any devices communicating with the content distribution system, such as publisher's device, end user/recipient's device and the content repositories.

Via the browser or mobile application, the trusted view engine 325 can prevent the user from or otherwise be limited in copying any portion of the digital content displayed. Via the browser or mobile application, the trusted view engine 325 can prevent the user from sharing the content with other users outside of the content distribution system, such as via email, texting or posting to a social networking site. Via the browser or mobile application, the trusted view engine 325 may watermark, mark or tag the digital content with information regarding the usage, such as the name of the user, the time of access, device information, source of digital content and/or publisher of the digital content.

The content distribution system, such as via the trusted view engine may convert, translate or transform a digital content from a content repository into a format used by the content distribution system to securely distribute and share such content. The content distribution system may obtain a copy of the digital content from a remote storage location of the content distribution system. The content distribution system may transform, covert or translate into an image format supported by the content distribution system. The content distribution system may transform, convert or translate from a plurality of different file formats into a single image format for distribution via the content translation system. For example, an office document, such as word processing document, spreadsheet or presentation may be converted, transformed or translated by the trusted view engine 325 or the content distribution system generally from its original or natural file format to a series of one or more images in any type and form of image format, such as jpeg. The trusted view engine 325 streams the digital content to the device via the browser or mobile application as a series or sequence of images representative of, comprising or displaying the content of the digital content. In some implementations, the trusted view engine 325 may be a part of the content distribution manager of the content distribution system.

The mobile application or widget, component or other executable instructions of the content distribution running in the browser may be designed, constructed and/or configured to provide viewing access to the digital content within a controlled viewing container. In some embodiments, the content distribution system via the mobile application or browser only provides access to images of the digital content one page at a time. Via the browser or mobile application, the trusted view engine 325 can provide access to images or portions thereof of the digital content that fits into or is viewable via a predetermined window or display size. The user may have to click a button or user interface element to move between pages or use keyboard buttons to scroll through or move between pages.

The analytics engine 330 is designed, constructed and/or configured to track usage analytics of the digital content. As the access and usage of the digital content flows through, traverses or otherwise is controlled and managed by the content distribution system, the content distribution system can track usage, such as via the analytics engine, of the digital content. The analytics engine 330 may identify, track and store any information about the usage of the digital content, including but not limited to time and date of access, information about device, browser and/or mobile application and information about the user. The analytics engine 330 may identify, track and store the number of times the user accessed the digital content and from what device(s). The analytics engine 330 may identify, track and store which pages of the digital content the user interacted with and for how long. The content distribution system may identify, track and store the different type of digital content a user has accessed and from what publishers.

The analytics engine 330 can also generate analytical reports using the usage information tracked and stored to a database. In some embodiments, the content publisher can submit a request, such a via the trusted share engine to generate one or more usage reports. The trusted share engine may provide an interface, such as dashboard, for a publisher to view statistics of usage of any digital content or across multiple digital content of the publisher. The publisher may view via the dashboard or reports the identity of users who accessed the digital content, the date and time of access, the number of times accessed, the length of time of access, the device id or device information (IP address, MAC Id, host name, etc.) from which the content was accessed, the geographic location of the access and the type of application and/or device from which the digital content was accessed. The publisher may view via the dashboard or reports which pages of the digital content was viewed most frequently or most often or by the most number of users. The publisher may view via the dashboard or reports which pages of the digital content was viewed the longest time. The publisher may view via the dashboard or reports which pages of the digital content was viewed the most or for the longer times on which days. The publisher may view via the dashboard or reports the number of days or amount of time after making the digital content available to user did the users access the digital content, such as the number of days or amount of time after which the user received notice or a prompt from the content distribution system. In some implementations, the analytics engine 330 may be a part of the content distribution manager of the content distribution system.

The policy/rule engine 335 (generally referred to as a policy engine) may be designed, constructed and/or configured to provide an interface to receive specification or configuration of rules of a policy, such as from the publisher, and to apply such policies to access of digital content. These policies may be configured by a user, such as an administrator of the content distribution system, publisher or delegate of the publisher. These policies may be configured programmatically via an application programming interface by another system, application or device. The policy may be configured to have a plurality of rules. The policy may use logical operators and expressions, such as ANDs and ORs between rules to combine the results of each rule into a single result or application of the policy. The policy may be configurable to have a priority assigned to each or one or more of the rules to have one rule override another rule or given priority over another rule.

The policy/rule engine 335 may be designed and constructed for the configuration or specification of rules for geographic location 340, dynamic expiration 342 and/or number and types of devices 344. A geographic location rule 340 may comprise any identification, specification or description of a location. The geographic location rule 340 may be specified by any breadth or granularity of geographic, such as continent, country, region, state or city. The geographic location rule 340 may be specified by latitude and longitude coordinates. The geographic location rule 340 may be specified by range of internet protocol addresses that may correspond to certain geographic regions or locations. The geographic location rule may be specified for the device, such as by its IP address, or by user, such as contact information or profile of the user. A geographical location rule may be specified for access or denial of access. For example, if the device is identified as being within a certain geography, access may be denied or if the device is identified as being with another geography, access may be authorized.

A dynamic expiration rule 342 may comprise any identification, specification or description of temporal conditions or constraints. The dynamic expiration rule may comprise a predetermined number of days at which access to the digital content expires. The dynamic expiration rule may comprise a scheduled date and/or time at which access to the digital content expires. The dynamic expiration rule may comprise a time period between which access to the digital content is allowed and when not within that time period access is not allowed. The dynamic expiration rule may comprise a predetermined number of accesses at which access to the digital content expires. The dynamic expiration rule may comprise a predetermined number of different users accessing the digital content at which access to the digital content expires. The dynamic expiration rule may comprise time period in the day at which access to the digital content expires or is not accessible. The dynamic expiration rule may comprise a time period in the day at which access to the digital content is allowed or accessible. The dynamic expiration rule may comprise identification of a time zone for which the temporal conditions apply. The dynamic expiration rule may comprise identification of a time and geographic location for which the temporal conditions apply.

A device based rule 344 may comprise any identification, specification or description of a predetermined number of devices and/or types or devices. A device based rule may specify a predetermined number of devices that can access the digital content. A device based rule may specify a predetermined number of devices per user. A device based rule may specify a predetermined number of devices per specific user. A device based rule may specify a predetermined number of devices for all users. A device based rule may specify a predetermined number of devices per specific user. A device based rule may specify the type of device which can access the digital content. A device based rule may specify the type of application on that device, such as browser or mobile application, which can access the digital content. For each device within the predetermined number of devices, a device based rule may specify the type of device which can access the digital content.

The policy/rule engine can apply the rules of the policies to the request and/or device to grant or authorize the device to access the digital content or to restrict/deny access to the digital content. The content distribution system via the policy/rule engine 335 may identify any policies applicable to the requested digital content. The policy/rule engine 335 may identify such polices based on the identity, name or description of the digital content, such as may be identified by the request. The policy/rule engine 335 may identify policies with one or more rules specifying the predetermined number of devices, the geographical location and/or dynamic expiration for the digital content. The policy/rule engine 335 may identify policies with one or more rules corresponding to a specific user. The policy/rule engine 335 may identify policies with one or more rules corresponding to a specific type or category of device. The policy/rule engine 335 may identify geographic location policies 340 with one or more rules corresponding to a specific geographic location. The policy/rule engine 335 may identify dynamic expiration policies 342 with one or more rules corresponding to a specific time or time period of access. The policy/rule engine 335 may identify device-based policies 344 with one or more rules corresponding to device-based restrictions. The policies and/or rule may be specified or configured at a level or granularity of a user, group of users, a device, type of device, location of device and/or time.

The policy/rule engine 335 may apply each of the rules of one or more policies to the request, device and/or digital content. Via one or more rules specifying a predetermined number of devices, the policy/rule engine 335 may determine if activating or otherwise providing access to the device requesting access would be allowed by the rule. Via a rule specifying a geographic location, the policy/rule engine may determine if activating or otherwise providing access to the device requesting access would be allowed by the rule. Via one or more rules specifying a dynamic expiration, the policy/rule engine may determine if access to the digital content has expired or will expire upon providing access to the device. Via one or more rule specifying a restriction on any combination of number of devices, types of devices, type of digital content, identify of user, geographic location, temporal constraints and dynamic expiration may be applied to the request of a user via a device to access a particular digital content or set of digital content.

In some embodiments, the policies or rules are provided by the content publisher. In some embodiments, the policies or rules are extracted from the digital content. In some embodiments, the policies or rules are extracted from the content repository in which the digital content is stored. Examples of policies or rules that can be implemented by the policy/rule engine 335 include but are not limited to limiting access to particular users, limiting access to a predetermined number of devices for each user, limiting access to users or user devices located within a particular geographic location, limiting access to users or user devices based on date and time parameters, limiting access to users or user devices based on a number of concurrent users or user devices accessing the digital content, amongst others. In some embodiments, the policy/rule engine 335 may communicate with the trusted view engine 325 to implement the rules or policies. In some embodiments, the policy/rule engine 335 dynamically monitors the digital content as well as the users or user devices accessing the digital content to ensure that the rules or polices are continually being implemented. In some embodiments, the policy/rule engine 335 can send a command to the trusted view engine causing the trusted view engine to stop providing one or more users or user devices access to the digital content responsive to determining that a rule or policy is triggered. In some implementations, the policy/rule engine 335 may be a part of the content distribution manager of the content distribution system.

The device activation engine 350 is designed, constructed and/or configured to activate one or more user devices to access digital content via the content distribution system. The device activation engine may identify or generate device ids 352A-N for assigning to activated devices. The device activation engine may manage device ids assigned to activated devices. The device activation engine may store and access device ids via a database. The device activation engine may determine whether or not a device id of a device accessing the content distribution system is a device id provided by or otherwise approved or authorized by the device activation engine.

The device activation engine 350 can generate device ids based on any function, algorithm or scheme to produce a unique device identifier for each device. In some embodiments, the device activation engine 350 generates its own device ids. The device id may be based on a random number generator. The device id may be based on a security key function, such as a cipher. The device may be of a predetermined number of bytes or length. In some embodiments, the device activation engine 350 generates the device id by applying a function, such as a hash function, to information or data about the device, such as host name, IP address, machine access id of the device. In some embodiments, the device activation engine 350 generates the device id by applying a function to any combination of information about the digital content (name, publisher, source, contents, etc.), a user (name, location, userid, etc.) and/or device (type, location, IP address, UUID, MAC id, etc.)

In some embodiments, the device activation engine 350 uses a device identifier provided by or identifiable via the device. The device identifier may be a universal user device identifier identified or accessible by, via or from the device, such as an IMEI number of a mobile device or a MAC address of a network component of the device. In some embodiments, the device identifier can be generated by the device activation engine 350 and provided to the device 102.

In some embodiments, the device activation engine 350 generates device ids unique to the device and the digital content the device is being activated. The device activation may generate devices ids for the same device for each of the multiple different digital content the device may be activated to access. As such, in some embodiments, the same device may have a first device id that is activated for a first digital content and a second device id activated for a second digital content. In other embodiments, the same device may have a first device id that is activated for a first digital content to which the device can access and a second device id not activated or deactivate for a second digital content that the device cannot access.

The content distribution system, via the device activation engine, can store in a database one or more unique device identifiers associated with the devices accessing the digital content. The content distribution system may provide or communicate the device id to the device for the device to store in memory or storage. The content distribution system may provide or communicate the device id to a widget, script, component or other types and forms of executable instruction executing within the browser and designed and constructed to work with the content distribution system. The widget, script, component or executable instructions may store the device id within memory or storage for retrieval and presenting to the content distribution system upon accessing digital content. The content distribution system may provide or communicate the device id to a mobile application designed and constructed to work with the content distribution system. The mobile application may store the device is within memory or storage for retrieval and presenting to the content distribution system upon accessing digital content. The device may store the device id in a registry setting. The device may store the device id to a cookie recognized by the content distribution system. The device may store the device in a browser setting, configuration or other data structure for retrieval and presenting to the content distribution system upon accessing digital content.

The activation engine activates devices at the time of access so that users have flexibility in accessing the digital content via devices selected or chosen by the user. Via activation and/or generation of device ids, the activation engine locks in, consumes or otherwise uses one of the predetermined number of devices that may be specified, associated or allocated to usage with the digital content. In this sense, the devices that may use or consume an allocation from predetermined number of devices to be used is floating. At the time of the request by the device and/or device activation, the device yet known or recognized by the content distribution system becomes known or recognized by the content distribution system and is associated, assigned or allocated to usage with the digital content. As a user accesses the digital content from different device, each device activation allocates or consumes one of the predetermined number of devices available for allocation by the user to access the digital content.

In some embodiments, the content distribution system determines that the user is not a user identified by the publisher for accessing or receiving access to the digital content. In some embodiments, the device activation engine 350 determines that the device is not to be activated for or given access to the digital content, such as because of exhaustion of the predetermined number of devices or otherwise as a result of applying a policy. Responsive to such determinations, the content distribution system does not provide any interface, such as graphical or otherwise, for the user to access the digital content via the device. Responsive to such determinations, the content distribution system, via the trusted view engine 325 may provide a communication, such as a message or notice, that the user and/or device will not have access to the digital content. Responsive to such determinations, the content distribution system may lock out, log out or otherwise prevent the user and/or device from accessing the digital content via the content distribution system. In some implementations, the activation engine 350 may be a part of the content distribution manager of the content distribution system.

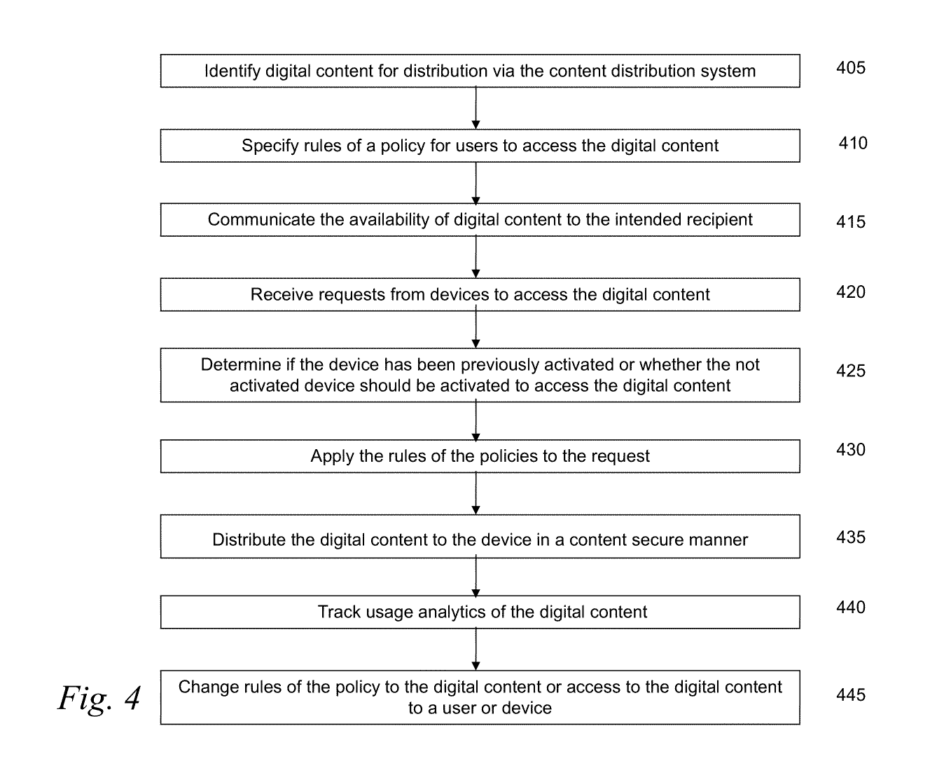

Referring now to FIG. 4, an embodiment of a method of distributing and controlling access to digital content via the content distribution system is depicted. In brief overview, at step 405, a publisher identifies digital content for distribution via the content distribution system. At step 410, the publisher may specify rules of a policy for users to access the digital content via the content distribution system, such as the number of devices, geographic location of the devices and expiration of the digital content. At step 415, the publisher or the content distribution system may communicate, such as via email, to users, such as user identified by the publisher, the availability of the digital content via the content distribution system. At step 420, the content distribution system receives requests from devices to access the digital content.

At step 425, the content distribution system determines if the device has been previously activated or whether the not activated device should be activated to access the digital content. At step 430, the content distribution system applies the rules of the policies to the request and/or device to grant or authorize the device to access the digital content or to restrict/deny access to the digital content. At step 435, if the device is authorized/granted, the content distribution system distributes, such as via streaming, the digital content to the device in a content secure manner. Otherwise, if the device is restricted/denied, the content distribution system does not distribute the digital content. At step 440, the content distribution system may track usage analytics of the digital content. At step 445, the publisher may change rules of the policy to the digital content or otherwise change access to the digital content to a user or device.

In further details of step 405, a publisher or owner of digital content (sometimes generally referred to as publisher) may identify via an interface (graphical, command line, application programming interface (API), etc.) of the content distribution system, digital content to be distributed and controlled via the content distribution system. The trust sharing engine of the content distribution system may provide an interface for a publisher to identify and configure digital content to be shared in a trusted manner via the content distribution system. The publisher of the digital content may identify a remote storage location of the digital content to the content distribution system, such as a uniform resource locator or file name to the digital content stored in or at a cloud storage system or device, such as a server, remote to the content distribution system. In some embodiments, the publisher may upload the digital content to a storage location of the content distribution system. In some embodiments, the publisher may upload the digital content to a remote storage location identified, specified or provided by the content distribution system.

The publisher of the digital content may identify any type and form of digital content, including but not limited to word processing documents, presentations, spreadsheets, portable document formats, media or multimedia files, etc. The publisher may identify a variety of different digital content to the content distribution system. The publisher may configure via the content distribution system, a title, description, publisher/owner or source and remote storage location of the digital content.

The publisher may identify the names or identities of specific or group of users who may access the digital content via the content distribution system, such as by email address or by user name within the content distribution system.

At step 410, the publisher of the digital content may specify or configure via an interface of the content distribution system, one or more rules of policies to apply by the content distribution system to control access to the digital content. Via an interface of the trusted share engine or policy engine, the publisher may specify or configure one or more rules of policies to apply to the digital content. The publisher may specify or configure rules and policies on a per digital content basis, such that different digital content (e.g., one document or file versus a different document or file) may have different rules and/or policies. The publisher may specify or configure rules and policies on a group or set of digital content, such that the digital content assigned to or part of a group or set have the same rules and/or policies.

The publisher may configure a rule of a policy to specify a predetermined number of device from which a specific or particular user may access the digital content via the content distribution system. The publisher may configure a rule of a policy to specify a predetermined number of devices from which any user may access the digital content via the content distribution system. The publisher may configure a rule of a policy to specify a type of device (such as desktop/laptop versus mobile, tablets or smartphone) for each of the predetermined number of devices. The publisher may configure a rule of a policy to specify a geographic location in which a device must be located to access the digital content. The geographic location may be specified or configured at any breadth or granularity, such as by continent, country, region, state or city. The publisher may configure a rule of a policy to specify temporal conditions or constraints on accessing the digital content. The publisher may configure a rule of a policy to specify a time of day during which the digital content may be accessed. The publisher may configure a rule of a policy to specify an a mount of time for which the digital content may be accessed by a user or device. The publisher may configure a rule of a policy to specify dynamic expiration of the digital content such as by a predetermined number of days or scheduled date.

At step 415, the publisher or the content distribution system may communicate the availability of the digital content via the content distribution system. The trusted view engine may provide an interface for sending communications to users. The publisher may instruct or request the content distribution system to send an electronic communication to one or more users at their corresponding contact information. The content distribution system may transmit an email to a corresponding email address of a user. The content distribution system may transmit a text (e.g., SMS or MMS) message to a user at a corresponding number. The content distribution system may submit or post a message to a web-site, such as a social networking site. The content distribution system may submit or post a message to a page of a user at a social networking site. The content distribution system may submit or post a message to an account of a user within the content distribution system. The content distribution system may provide a notification via a mobile application of a mobile device of a user.

The publisher may communicate information about the digital account and/or a uniform resource locator of the content distribution system to one or more users, such as by any of the above communication means external to or separate from the content distribution system. For example, the content distribution system may provide the publisher a URL for the publisher to communicate or share with others by email, posting, texting or otherwise.

At step 420, the content distribution system, such as via the trusted view engine, receives requests from devices to access the digital content. A user on a device may receive a communication via step 415 on the same device or a different device and responsive to such communication request access to the digital content. The content distribution system may receive the request from a browser opening up a web page of or otherwise accessing a URL. The user may select or click on a link or URL within the communication to access the digital content via the content distribution system. The user may type in the URL into a browser. The content distribution system may receive the request from a mobile application communicating with the server of the content distribution system. The content distribution system may receive the request via an API call made by another device, such as via an application designed and constructed to interface with the content distribution system.

The content distribution system may allow the user to access the digital content from any device subject to any policies applicable to that digital content. The content distribution system may allow the user to choose or select the device to which the user may desire to access the digital content subject to any policies applicable to that digital content. The predetermined number of devices may be floating or otherwise unallocated or unassigned to the digital content until the time of request and/or activation. The content distribution system may receive the request from a device not yet identified or known by the content distribution system. The content distribution system may receive the request from a device not yet activated or authorized by the content distribution system. The content distribution system may receive the request from a device previously activated or authorized by the content distribution system. The content distribution system may receive the request from a device previously identified or known by the content distribution system. The content distribution system may receive the request from a device associated with or allocated to usage with the digital content or otherwise allocated to one of the predetermined number of devices.

At step 425, the content distribution system, such as via the device activation engine, identifies or determines the activation status of the device. The content distribution system may determine if the device provided, via the request, a device identifier assigned by the content distribution system. In some embodiments, the content distribution system determines that a cookie provided with the request has a device identifier generated by the content distribution system. In some embodiments, the content distribution system determines the request does not have such a cookie or otherwise a device identifier generated and/or assigned by the content distribution system. The content distribution system may determine via a request or other communication from a mobile application that the device of the mobile application has a device identifier generated and/or assigned by the content distribution system. The content distribution system may determine via a request or other communication from a mobile application that the device of the mobile application does not have a device identifier generated and/or assigned by the content distribution system.

Via the presence or absence of the device identifier, the content distribution system may determine if the device has been previously activated or whether the not activated device should be activated to access the digital content. By activating a device, the content distribution system locks in, consumes or otherwise uses one of the predetermined number of devices that may be specified, associated or allocated to usage with the digital content. At the time of the request by the device and/or device activation, the device yet known or recognized by the content distribution system becomes known or recognized by the content distribution system and is associated, assigned or allocated to usage with the digital content. As such, at the time of request and/or activation, one of the floating number of devices to use with the digital content becomes allocated to or associated with a specific device.

In some embodiments, the content distribution system determines the device identifier identified by the request and/or device is already associated with usage with the digital content. In some embodiments, the content distribution system determines the device identifier identified by the request and/or device is already allocated to a number of uses with the digital content. In some embodiments, the content distribution system generates a device identifier for the device and determines if the device identifier is already associated with usage with the digital content. The content distribution system may determine if the device identifier is already allocated to a number of uses with the digital content. In some embodiments, the content distribution system determines whether or not all the predetermined number of uses for the digital content have been allocated or used. The content distribution system may only generate a device identifier if there are remaining number of device(s) available or unallocated in the predetermined number of devices for the digital content.

If the device has not been activated and there are available number of devices unallocated in the predetermined number of devices and/or the policies allow for such activation, the content distribution system, via the activation engine, may generate and assign a device id to the device and allocate one of the predetermined number of devices to the device. The content distribution system may communicate the device identifier to the device. In some embodiments, the content distribution system communicates a cookie identifying or comprising the device identifier to the device. In some embodiments, the content distribution system communicates via a message, API call or otherwise, the device id to the mobile application. The device may store the device identifier in memory and/or storage, such as via a cookie or the mobile application.

The content distribution system and device activation module may activate devices and/or provide device identifiers on a per digital content basis. For example, although a device may be activated and/or allocated one of the predetermined number of devices for a first digital content, the same device may not be activated and/or allocated one of the predetermined number of devices for a second digital content. As such, in some embodiments, the device id may be generated to be unique to both the device and the particular digital content being accessed.

At step 430, the content distribution system, via the police engine, applies the rules of the policies to the request and/or device to grant or authorize the device to access the digital content or to restrict/deny access to the digital content. The content distribution system via the policy/rule engine may identify any policies applicable to the requested digital content. The content distribution system may identify such polices based on the identify, name or description of the digital content, such as may be identified by the request. The content distribution system may identify policies with one or more rules specifying the predetermined number of devices, the geographical location and/or dynamic expiration for the digital content. The content distribution system may identify policies with one or more rules corresponding to a specific user. The content distribution system may identify policies with one or more rules corresponding to a specific type or category of device. The content distribution system may identify policies with one or more rules corresponding to a specific geographic location. The content distribution system may identify policies with one or more rules corresponding to a specific time or time period of access. The policies and/or rule may be specified or configured at a level or granularity of a user, group of users, a device, type of device, location of device and/or time.

The policy/rule engine may apply each of the rules of one or more policies to the request, device and/or digital content. Via rule specifying a predetermined number of devices, the policy/rule engine may determine if activating or otherwise providing access to the device requesting access would be allowed by the rule. Via a rule specifying a geographic location, the policy/rule engine may determine if activating or otherwise providing access to the device requesting access would be allowed by the rule. Via a rule specifying a dynamic expiration, the policy/rule engine may determine if access to the digital content has expired or will expire upon providing access to the device. Via one or more rule specifying a restriction on any combination of number of devices, types of devices, type of digital content, identify of user, geographic location, temporal constraints and dynamic expiration may be applied to the request of a user via a device to access a particular digital content or set of digital content.

At step 435, if the device and/or user is authorized/granted, the content distribution system provides access, such as via the trusted view engine, to the digital content to the device in a content secure manner, such a via streaming a page by page view. In the case of a browser, the device may receive access in a secure manner to the digital content within a browser. The content distribution system may provide a widget, script, applet, application or other type and form of executable instructions executing within the memory of the browser to provide, display and control display and access to the digital content in a secure manner. Likewise, for a mobile application access to the content distribution system, the mobile application may be designed and constructed to provide, display and control display and access to the digital content in a secure manner. Via the browser or mobile application, the user may be prevented from or otherwise be limited in copying any portion of the digital content displayed. Via the browser or mobile application, the user may be prevented from sharing the content with other users outside of the content distribution system, such as via email, texting or posting to a social networking site. Via the browser or mobile application, the content distribution system may watermark, mark or tag the digital content with information regarding the usage, such as the name of the user, the time of access, device information, source of digital content and/or publisher of the digital content.

Via the browser or mobile application, the content distribution system may only provide access to images of the digital content one page at a time. Via the browser or mobile application, the content distribution system may only provide access to images or portions thereof of the digital content that fits into or is viewable via a predetermined window or display size. The user may have to click a button or user interface element to move between pages or use keyboard buttons to scroll through or move between pages. For example, an office document, such as word processing document, spreadsheet or presentation may be converted, transformed or translated by the content distribution system from its original or natural file format to a series of one or more images in any type and form of image format, such as jpeg. In this sense, the content distribution system streams the digital content to the device via the browser or application as a series or sequence of images representative of, comprising or displaying the content of the digital content.

Otherwise, at step 435, if the device or user is restricted/denied, the content distribution system does not distribute the digital content. In some embodiments, the content distribution system determines that the user is not a user identified by the publisher for accessing or receiving access to the digital content. In some embodiments, the content distribution system determines that the device is not to be activated for or given access to the digital content, such as because of exhaustion of the predetermined number of devices or otherwise as result of applying a policy. Responsive to such determinations, the content distribution system does not provide any interface, such as graphical or otherwise, for the user to access the digital content via the device. Responsive to such determinations, the content distribution system may provide a communication, such as a message or notice, that the user and/or device will not have access to the digital content. Responsive to such determinations, the content distribution system may lock out, log out or otherwise prevent the user and/or device from accessing the digital content via the content distribution system.

At step 440, the content distribution system may track usage analytics of the digital content. As the access and usage of the digital content flows through, traverses or otherwise is controlled and managed by the content distribution system, the content distribution system can track usage, such as via the analytics engine, of the digital content. The content distribution system may identify, track and store any information about the usage of the digital content, including but not limited to time and date of access, information about device, browser and/or mobile application and information about the user. The content distribution system may identify, track and store the number of times the user accessed the digital content and from what device(s). The content distribution system may identify, track and store which pages of the digital content the user interacted with and for how long. The content distribution system may identify, track and store the different type of digital content a user has accessed and from what publishers.

At step 445, the publisher may change rules of the policy to the digital content or otherwise change access to the digital content to a user or device. Based on reviewing usage analytics, a publisher may change any of the policies for the digital content. In some embodiments, via the trusted share engine, a publisher may deactivate any particular device in use or activated for use with a particular digital content. In some embodiments, via the trusted share engine, a publisher may deactivate any particular user from accessing a particular digital content. In some embodiments, via the trusted share engine, a publisher may stop or prevent a user from continuing to access a digital content while they are currently accessing the digital content. In some embodiments, via the trusted share engine, a publisher may remove, change or add what controls the user may have in accessing a digital content either before they access or while they are currently accessing the digital content. For example, the publisher may remove and/or add the capability to print, search, share, comment/annotate, bookmark, add notes or save the digital content.

C. Systems and Methods of Controlling Access of Digital Content that is Shared with Indirect Contacts

As described above, a content publisher can control access to digital content by providing access to the content to users that the content publisher has directly provided access. Such users can be referred to as direct contacts of the content publisher or first degree users. The content publisher can directly provide access to a user by specifying, via the content distribution system, the identity of the user or a group of users of which the user is a part. However, there are times when the content publisher may wish to allow the user to share the content with other users with whom the content publisher cannot or has not directly shared the content while, at the same time, maintaining control over who is accessing the content. For example, the content publisher may desire to relax some of the restrictions on sharing to allow the content to be shared virally. Such users with whom the content publisher cannot or has not directly shared the content can be referred to as indirect contacts of the content publisher or second degree users. The content distribution system can be configured to establish and implement a sharing policy provided by the content publisher by which the content can be shared with one or more users in accordance with the sharing policy.

The content publisher may establish and implement a sharing policy via the content distribution system by which one or more users to whom the content publisher has previously allowed access can share access to the contact with one or more second degree users to the content publisher. Second degree users to the content publisher may be indirect contacts to the content publisher and are users to whom the content publisher has not previously directly provided access to the content. These users may or may not be known to the content publisher. In this way, the content publisher can share access to the content via direct contacts with one or more users that are indirect contacts of the content publisher, while maintaining control of the access to the content such that only a limited number of indirect users can access the content. As such, the content distribution system can be further configured to share access to content for viral distribution with one or more clients that are indirectly connected to the content publisher.

In some implementations, the sharing policy can include one or more rules for controlling access to the content, such as to indirect contacts of the content publisher that may receive access to the content from direct contacts of the publisher. The sharing policy can be configured to restrict sharing the content to one or more of a predetermined number of direct and indirect users, geographic regions or locations from where the content can be accessed, temporal limitations within which the content can be accessed, types of devices through which the content can be accessed, users that belong to a group, for example, users associated with a particular web domain, amongst others.

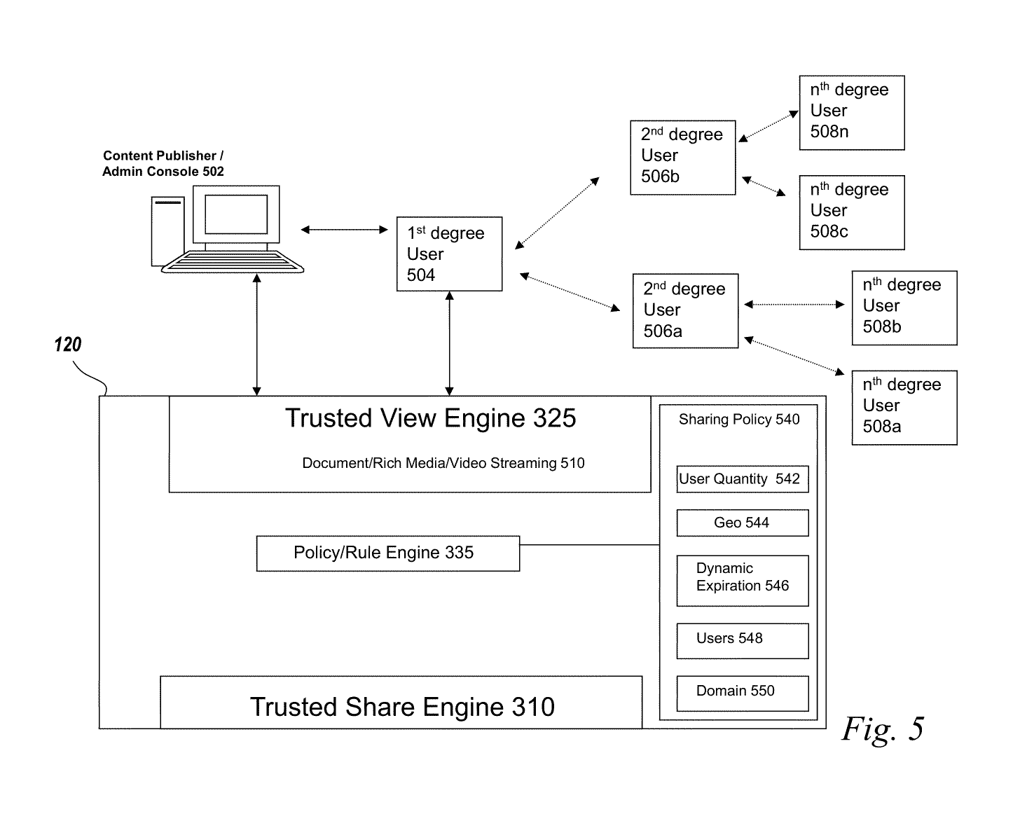

FIG. 5 is a block diagram of a system for secure digital content distribution in accordance with one or more sharing policies. The system includes the content distribution system 120 that is configured to control the sharing of digital content with indirect contacts of the content publisher. The system allows the content publisher to utilize trusted sharing by allowing users that have access to the digital content to share the content with other users while still controlling access to the digital content. A content publisher 502 can provide access to digital content 510 owned or published by the content publisher 502 to a first degree user, such as the user 504. In addition to the content publisher 502 providing access to content to the first degree user 504, the content publisher 502 can also establish a sharing policy according to which the user 504 can share the content with other users, for example, second degree users 506a and 506b. Such users may not be directly connected with the content publisher but may be connected to the content publisher via the user 504. Moreover, the content publisher 502 can also establish a sharing policy according to which the users 506a and 506b, which are indirect contacts of the content publisher 502, can share the contact with other users, such as nth degree users 508a-508n that are direct contacts of the second degree users 506a and 506b. Although the description of FIG. 5 may be limited to defining sharing policies to control sharing the content to 2^{nd} and 3^{rd} degree users, the content distribution system can establish sharing policies that control sharing the content to 4^{th} degree, or n^{th} degree users, such as via viral distribution of content.

The content distribution system 120 can include the trusted share engine 310, the trusted view engine 325 and the policy/rule engine 335. The content publisher 502 and users 504, 506 and 508 can communicate with the content distribution system 120 via the trusted view engine 325. The content publisher 502 can be configured to establish and implement a sharing policy 540 for sharing access to the content via the policy/rule engine 335. The policy/rule engine 335 may be designed and constructed for the configuration or specification of rules for one or more sharing policies 540. The sharing policy 540 includes one or more rules for controlling the trusted sharing of digital content, such as between direct contacts of the content publisher and indirect contacts of the content publisher.

The policy/rule engine 335 can be configured to receive, via the trusted view engine 325 of the content distribution system, configuration or specification of the sharing policy 540 from the content publisher 502. The content publisher 502 can provide one or more instructions corresponding to the configuration or specification of the sharing policy to the policy/rule engine 335. The policy/rule engine 335 can be configured to generate a sharing policy based on the instructions received from the content publisher. The sharing policy 540 can be specific to a particular content item or specific to one or more content items published by the content publisher. In addition, the content publisher can, via the policy engine, establish and implement sharing policies that are specific to each of the users 504 to whom the content publisher has provided access to the content. In some implementations, the content publisher can, via the policy engine, establish and implement sharing policy to a group of users.

The policy/rule engine 335 can be configured to receive a request from a device of a direct contact to share content with one or more second degree users or indirect contacts via the content distribution system. The policy/rule engine 335 can be configured to determine if the user is authorized to share content with the one or more other users based on one or more sharing policies 540. In some implementations, the sharing policy may be specific to the content. In some implementations, the sharing policy may be specific to the user requesting to share the content. In some implementations, the sharing policy may be specific to the content publisher 502 that published the content. In some implementations, the sharing policy may place restrictions on a number and type of clients associated with a user with whom access to the content is being shared. For example, the sharing policy may restrict a user's ability to access the content to a number and/or types of devices.

The policy/rule engine can apply the rules of the sharing policies to the request and/or client to grant or authorize the second degree user 506 to access the digital content or to restrict/deny access to the digital content. The content distribution system 120 via the policy/rule engine 335 may identify any policies applicable to the requested digital content. The policy/rule engine 335 may identify such polices based on the identity, name or description of the digital content, such as may be identified by the request. The policy/rule engine 335 may identify policies with one or more rules specifying the predetermined number of devices, the geographical location and/or dynamic expiration for the digital content. The policy/rule engine 335 may identify policies with one or more rules corresponding to a specific user. The policies and/or rules may be specified or configured at a level or granularity of a user, group of users, a device, type of device, location of device and/or time.

In some embodiments, the policies or rules are provided by the content publisher. In some embodiments, the policies or rules are extracted from the digital content. In some embodiments, the policies or rules are extracted from the content repository in which the digital content is stored. Examples of policies or rules that can be implemented by the policy/rule engine 335 include but are not limited to limiting access to particular users, limiting access to a predetermined number of devices or clients for each user, limiting access to users or user devices located within a particular geographic location, limiting access to users or user devices based on date and time parameters, limiting access to users or user devices based on a number of concurrent users or user devices accessing the digital content, amongst others. In some embodiments, the policy/rule engine 335 may communicate with the trusted view engine 325 to implement the rules or policies. In some embodiments, the policy/rule engine 335 dynamically monitors the digital content as well as the users or user devices accessing the digital content to ensure that the rules or polices are continually being implemented. In some embodiments, the policy/rule engine 335 can send a command to the trusted view engine causing the trusted view engine to stop providing one or more users or user devices access to the digital content responsive to determining that a rule or policy is triggered.

The policy/rule engine 335 may apply each of the rules of one or more sharing policies to the request, device and/or digital content. Based on the rules of the one or more sharing policies, the policy/rule engine 335 may determine if the content can be shared. One or more rules specifying a restriction on one or any combination of number of devices, types of devices, type of digital content, identity of user, geographic location, temporal constraints and dynamic expiration may be applied to the request of a user via a device to share the digital content.

In particular, the sharing policy 540 can include one or more rules that define a number of users with which the content can be shared based on one or more user quantity rules 542, one or more geographic locations associated with users with which the digital content can be shared based on one or more geographical rules 544, the time during which the content can be shared or accessed based on one or more dynamic expiration rules 546, the type and/or identities of users with which the content can be shared based on one or more user type rules 548, a domain associated with one or more users with which the content can be shared based on domain type rules 550, amongst others.

A user quantity rule 542 may comprise any identification, specification or description of a number of users, such as for trusted sharing of a sharing policy. The user quantity rule 542 may be specified by a number of users, a group of users, a number of user devices, amongst others. The user quantity rule can be specific to a particular user, such as the first degree user 504. In some implementations, the user quantity rule 542 can be specific to the digital content or a group of digital content. In some implementations, the user quantity rule 542 can be specific to a particular content publisher. In some implementations, the sharing policy 540 can include a combination of user quantity rules and the sharing policy can be specific to a content item, a content publisher, and/or a particular user. A user quantity rule 542 may be specified for sharing content with other users. For example, if the maximum number of shares for the content has not been exceeded, the policy/rule engine 335 allows sharing the content with another user. However, if the maximum number of shares for the content is reached, the policy/rule engine can deny sharing the content with the user. The content publisher can provide, via the trusted view engine, a user quantity rule 542 such that the content publisher maintains control over a maximum number of users, devices, or groups of users with which the content can be shared. The user quantity rule can specify a maximum number of shares for each user, group of users, or for the content itself. The user quantity rule can specify a number of second degree users with which a first degree user can share the content. For example, the content publisher can specify that the first degree user can share the content with a maximum of five users. The policy/rule engine 335 can monitor the number of shares made by the first degree user and can deny sharing the content with second degree users with whom the first degree user would like to share the content once the first degree user has reached the number of shares specified by the content publisher.

A geographic location rule 544 may comprise any identification, specification or description of a location, such as for trusted sharing of a sharing policy. The geographic location rule 544 may be specified by any breadth or granularity of geographic, such as continent, country, region, state or city. The geographic location rule 544 may be specified by latitude and longitude coordinates. The geographic location rule 544 may be specified by range of internet protocol addresses that may correspond to certain geographic regions or locations. The geographic location rule may be specified for the device, such as by its IP address, or by user, such as contact information or profile of the user. A geographical location rule may be specified for sharing or denial of sharing. For example, if the user with whom the content is being shared is identified as being within a certain geography, sharing may be denied or if the user with whom the content is being shared is identified as being with another geography, sharing may be authorized. In some implementations, the geographic location rule may be specified for the location of the user sharing the device. For example, if the user sharing the content is identified as being within a certain geography, sharing may be denied or if the user sharing the content is identified as being with another geography, sharing may be authorized.

A dynamic expiration rule 546 may comprise any identification, specification or description of temporal conditions or constraints, such as for trusted sharing of a sharing policy. The dynamic expiration rule may comprise a predetermined number of days at which the ability or privilege to share the digital content expires. The dynamic expiration rule may comprise a scheduled date and/or time at which the ability or privilege to share the digital content expires. The dynamic expiration rule may comprise a time period between which the ability or privilege to share the digital content is allowed and when not within that time period the ability or privilege to share is not allowed. The dynamic expiration rule may comprise a predetermined number of shares at which the ability or privilege to share digital content expires. The dynamic expiration rule may comprise time period in the day at which access to the digital content expires or is not accessible. The dynamic expiration rule may comprise a time period in the day at which the digital content can be shared. The dynamic expiration rule may comprise identification of a time zone for which the temporal conditions apply. The dynamic expiration rule may comprise identification of a time and geographic location for which the temporal conditions apply.

A user rule 548 may comprise any identification, specification or description of users with which the content can be shared. The user rule may comprise types of users with which the content can be shared. The user rule can be specific to a particular user trusted to share the content. The user rule can be specific to restrict sharing of the content to users that are identified by the user sharing the content. For example, the user sharing the content has to have direct contact with the user with whom the user requests to share the content. In some implementations, the user can establish direct contact by providing contact information identifying the user, for example, a name, email address, alias, amongst others. In some implementations, the user rule can specify that the user can share the content with one or more users that belong to a particular group of users. For example, the user may wish to share the content with a group of users that belong to a particular department. Even though the user does not identify the users with whom to share the content, the user identifies the group of users. In this way, even though the user may not have direct contact with the user, the user can still share the content with the user as long as the user belongs to a particular group of users specified by the user rule 548.

The user rule 548 can in conjunction with the geographical rule 544 specify that the content be shared with users within a particular geographic region. The user rule 548 can specify that the content be shared with users matching a particular profile. The user rule 548 can also specify that the content be shared with users from a list of users identified by the content publisher. The user rule 548 can specify that the content be shared with users that belong to a particular organization, team, department or other group of users. In some implementations, the user rule 548 can in conjunction with the user quantity rule 542 specify that the content can be shared with only a predetermined number of users for one or more types of users. For example, the content publisher can set a sharing policy that limits a first degree user from sharing the content with no more than three people belonging to a first organization and sharing the content with no more than five people belonging to a second organization. The user rule 548 can also specify relationships between the user sharing the content and the user with whom the content is requested to be shared. For example, the content can be shared with second degree user with whom the first degree user sharing the content has an existing relationship. Examples of types of relationships can be existing business partners, service consultants, contractors, sub-contractors, outside vendors, amongst others.

A domain rule 550 may comprise any identification, specification or description of web domains and users associated with such web domains with whom the content can be shared. The domain rule may comprise types of domains with which the content can be shared. The domain rule can be specific to a particular user trusted to share the content. The domain rule can be specific to the digital content. The domain rule can be specific to allow or restrict sharing of the content to users that associated with a particular domain. For example, a user can only share content with users that have an email address or affiliation that includes a particular domain, or alternatively, the user can not share content with users that have an email address or affiliation with another domain. In some implementations, the domain rule can specify may comprise types of domains with which access to the content can be limited or allowed. For example, the domain rule can specify one or more domains associated with one or more social networks with which sharing the content can be limited or allowed. In this way, if the domain rule comprises a rule that limits the sharing of content on a domain name of a social network, the content cannot be shared on the social network, thereby preventing users of the social network from accessing the content through the social network. Conversely, if the domain rule comprises a rule that allows the sharing of content on a domain name of a social network, the content can be shared with users of the social network.

The sharing policy 540 can include one or more additional rules that may be inherited from an access policy of the content. The access policy of the content can define the parameters for accessing content by a user. For example, if the access policy has a geographic location rule that only allows users within a particular geographic location to access to the content, the policy/rule engine 335 can inherit such a rule in the sharing policy associated with the content such that a user cannot share the content with other users that are not within the particular geographic location included in the access policy. Similar rules related to the types of users that can access the content, the types of devices through which the content can be accessed, the time during which the content can be accessed can also be inherited by the sharing policy.

In some implementations, the sharing policy can be applied to a digital content such that any user that has access to the content can share the content in accordance with the sharing policy. In some implementations in which the content publisher defines the sharing policy, the content publisher is able to maintain control over how the content is shared. In some implementations, the content publisher can grant or revoke sharing privileges to one or more users according to the sharing policy. In some implementations, the content publisher can monitor and track the activities of each of the users that access and/or share the content, and can grant or revoke the access and/or sharing privileges of any of the users at any time. In some implementations, the content publisher can retroactively modify the access and/or sharing privileges of one or more users such that any activities that the user or other users that received access from the user whose privileges are being modified can also be modified. To do so, the policy/rule engine 335 can modify the sharing policies of the content responsive to instructions received from the content publisher 502. For example, if the content publisher revokes the sharing privileges of a first degree user who had shared the content with a second degree user, the content distribution system can revoke the second degree user's access and/or sharing privileges in response to determining that the first degree user's privileges have been revoked.

To do so, the content distribution system 120 maintains an activity/privileges log 560 of the activity and privileges provided to one or more users associated with the content. The activity/privileges log can be stored in a content repository, such as the content repository 315. In some implementations, the content publisher can access the activity/privileges log to view the access and sharing activity of the content. The content publisher can, via the trusted view engine, establish or modify new or existing sharing policies.

In some implementations, the sharing policy can also include one or more rules for limiting or allowing access to one or more client or user devices associated with users. In some implementations, such rules can limit the number of user devices through which a single user can access content. In some implementations, the sharing policy can include one or more rules for limiting access to a maximum number of clients or user devices regardless of the number of users to whom access to the content is provided. In some implementations, the sharing policy can include one or more rules that limit access to the content to one or more particular types of user devices. For example, one or more rules may limit access to the content to tablets and mobile phones. In some implementations, a user that requests to provide access of the content with an indirect contact can request to limit the indirect contact's ability to access the content to one or more types of user devices. In some other implementations, the user can request to limit the indirect contact's ability to access the content to a maximum number of user devices.

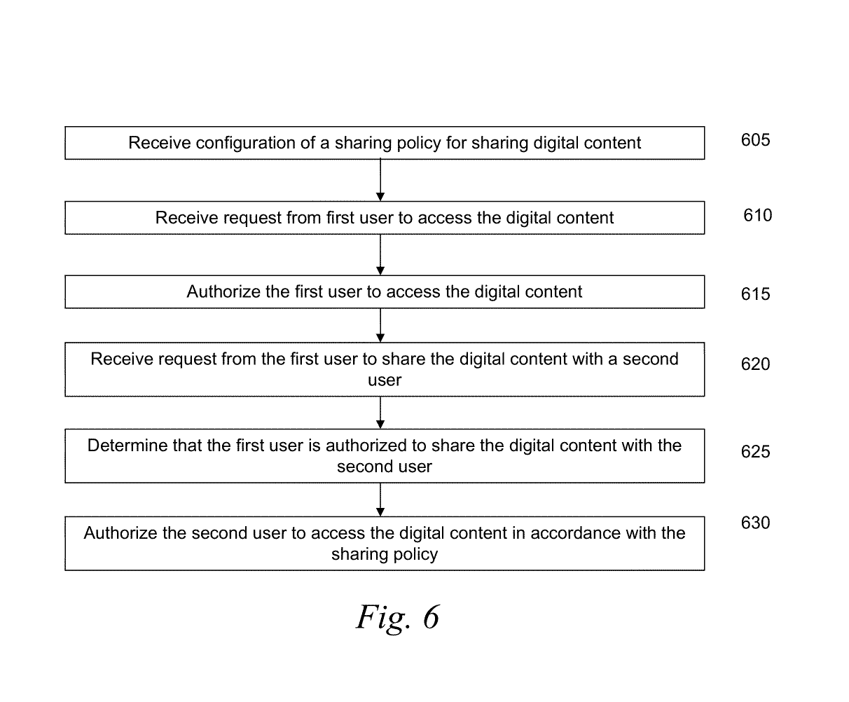

Referring now to FIG. 6, an embodiment of a method of sharing digital content via the content distribution system while maintaining control over access to the digital content is depicted. In brief overview, at step 605, a content distribution system receives configuration of a sharing policy for sharing digital content from a content publisher that published the digital content. At step 610, the content distribution system receives a request to access the digital content from a first user. At step 615, the content distribution system authorizes the first user to access the digital content. At step 620, the content distribution system receives a requests from the first user to share content with a second user. At step 625, the content distribution determines that the first user is authorized to share the digital content with the second user in accordance with the sharing policy. At step 630, the content distribution system authorizes the second user to access the digital content in accordance with the sharing policy.

In further detail, the content distribution system receives configuration of a sharing policy for sharing digital content from a content publisher that published the digital content. The content publisher can provide configuration of a sharing policy via the trusted view engine of the content distribution system. The content publisher can provide instructions, which the policy engine of the content distribution system can interpret into one or more rules that make up the sharing policy. In some implementations, the sharing policy can be inherited from an access policy previously defined by the content publisher. The rules can be created for providing one or more users or devices of users which the content publisher has previously authorized to share content with other users in a trusted manner. The rules can identify one or more users or devices of users to whom the content publisher has approved for sharing the digital content in accordance with one or more sharing policies. In some implementations, each of the users or devices of users to whom the content publisher has provided sharing privileges can have a specific sharing policy. In some implementations, a single sharing policy can apply to more than one user. In some implementations, one or more sharing policies can apply to the digital content such that any user that wishes to share the content can do so in accordance with the sharing policy of the digital content. The rules, which are based on the received configurations, can be user quantity rules 542, geographic rules 544, dynamic expiration rules 546, user rules 548, domain based rules 550, amongst others. Via the rules, the content distribution system can grant or deny sharing the content with one or more users.

At step 610, the content distribution system receives a request to access the digital content from a first user. The content distribution system can receive a request to access digital content from a first user in response to sending a notification to the first user that the first user is approved to access the content. In some implementations, the content distribution system can receive a request from the content publisher to provide access to the first user. The content publisher can assign such users sharing privileges in accordance with one or more sharing policies. In some implementations, the content publisher can limit the sharing privileges to only those users whom the content publisher requested the content distribution system to provide access.

At step 615, the content distribution system authorizes the first user to access the digital content. In some implementations, the content distribution system authorizes the first user to access the digital content in accordance with one or more access policies. The policy engine can be configured to determine if the first user is authorized to access the digital content. FIGS. 3 and 4 describe how the content distribution system authorizes the first user to access the digital content.

At step 620, the content distribution system receives a requests from the first user to share content with a second user. The content distribution system can receive the request from the first user in response to providing the first user access to the digital content. The content distribution system can determine if the first user is authorized to share the digital content. In some implementations, the content distribution system can determine that the first user is authorized to share the content based on a sharing policy of the first user and/or digital content.

At step 625, the content distribution system determines that the first user is authorized to share the digital content with the second user in accordance with the sharing policy. In some implementations, upon receiving a request from the first user to share content with a second user, the content distribution system can determine that the first user has been authorized to share the content in accordance with the sharing policy. If the content distribution system determines that the first user has been authorized the share the content, the content distribution system then determines if the first user is authorized to share the content with the second user in accordance with the sharing policy. In some implementations, the second user may satisfy the rules to access the digital content in accordance with the access policy for accessing the digital content, but may not satisfy the rules to receive access to the digital content in accordance with the sharing policy. For example, the access policy may include a rule that authorizes all users that are affiliated with a particular domain name to access the content. However, the first user is not authorized to the share the digital content with users of that particular domain in accordance with the sharing policy. As such, the sharing policy restricts the ability of the first user to share the digital content with other users, while the access policy restricts the ability of the second user to access the digital content.

In some implementations, the content distribution system can, in response to receiving the request from the first user, identify the second user with whom the first user has requested to share the content. The content distribution can then determine if the first user is allowed to share the content with the second user in accordance with the sharing policy. If the content distribution system determines that the first user can share the content with the second user in accordance with the sharing policy, the content distribution system can notify the second user that the digital content has been shared with the second user. The request to share content with the second user may not identify the second user. Rather, the request can include information that identifies a type of user or a group of users to whom the second user belongs. In some implementations, the request can include an email address of the second user. The policy/rule engine can determine if the first user is allowed to share the digital content with users associated with a domain name or the particular email address in accordance with the sharing policy. Once the policy/rule engine determines that the first user is allowed to share the digital content with such users, the policy/rule engine can then determine if such users are authorized to access the digital content in accordance with the sharing policy.

The policy/rule engine may apply each of the rules of one or more sharing policies to the request, first user and/or digital content. Via a rule specifying a quantity of users, the policy/rule engine may determine if sharing the content with the second user is allowed by the rule. In particular, the policy/rule engine may determine a number of users with whom the content has been shared. In some implementations, the content distribution system maintains an activities/privileges log that tracks the activity and privileges associated with each content or user. In some implementations, the policy/rule engine can manage and update the sharing policies and access policies to include a list of users with whom the content is shared and a list of users that have been authorized to access the content. The content distribution system can determine a number of times the user has shared the content, a number of times the content has been shared by all of the users, and a number of users that have been authorized to access the content. If, based on the user quantity rule, the number of users with whom the content has been shared has not reached the maximum number of users, the content distribution system determines that the user quantity rule has been satisfied. Via a rule specifying a geographic location, the policy/rule engine may determine if sharing content to a particular geographic region is allowed by the rule. Via a rule specifying a dynamic expiration, the policy/rule engine may determine if access to the digital content has expired or will expire upon providing access to the user with whom the content is being shared. One or more rules specifying a restriction on any combination of number of devices, types of devices, type of digital content, identity of user, geographic location, temporal constraints and dynamic expiration may be applied to the request of a user share digital content with the second user.

At step 630, the content distribution system authorizes the second user to access the digital content in accordance with the sharing policy. The content distribution system can authorize the second user to access the digital content in response to determining that the second user is authorized to access the digital content in accordance with the sharing policy. The policy/rule engine can, via the one or more rules of the sharing policy, determine that the second user is allowed to access the digital content in accordance with the sharing policy. The content distribution system can be configured to notify the second user that the second user is authorized to access the digital content.

In some implementations, the content distribution system can, upon notifying the second user that the second user has access to the digital content, receive a request to access the digital content. The content distribution system can identify the second user and determine that the second user is authorized to access the content. The content distribution system can then determine if the second user is authorized to access the content in accordance with the access policy of the digital content. If the content distribution system determines that the request to access the content complies with the access policy of the digital content, the content distribution system can authorize the second user to access the content. However, if the content distribution system determines that the request does not comply with the rules of the access policy, the content distribution system can deny the second user from accessing the content.

Moreover, the content distribution system can maintain and update the activity/privileges log of the digital content such that the content publisher can monitor the activity of the digital content. The activity/privileges log can inform the content publisher of when the content was accessed, the number of times it was accessed, the locations from where the content was accessed, the types of devices through which the content was accessed, the users who accessed the devices, the relationships between the users that accessed the device, the number of users that have authorization to access the content, the number of users with whom one or more of the users has shared the content, amongst others. In this way, the content publisher is able to evaluate the performance of the digital content in a measured way. Moreover, the content publisher can modify access and sharing privileges of one or more of the users via the policy/rule engine.

While the invention has been particularly shown and described with reference to specific embodiments, it should be understood by those skilled in the art that various changes in form and detail may be made therein without departing from the spirit and scope of the invention described in this disclosure.

While this specification contains many specific embodiment details, these should not be construed as limitations on the scope of any inventions or of what may be claimed, but rather as descriptions of features specific to particular embodiments of particular inventions. Certain features described in this specification in the context of separate embodiments can also be implemented in combination in a single embodiment. Conversely, various features described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

What is claimed:

1. A method for sharing digital content via the content distribution system while maintaining control over access to the digital content, the method comprising:
(a) receiving, via a content distribution system having one or more processors, from a publisher of digital content, configuration of a sharing policy for sharing the digital content;
(b) receiving, by the content distribution system, a first request of a first user to access the digital content;
(c) providing, by the content distribution system access to the first user, to the digital content;
(d) receiving, by the content distribution system, a second request of the first user to share the digital content with a second user;
(e) determining, by the content distribution system, based on the sharing policy, that the first user is authorized to share the digital content with the second user; and
(f) providing, by the content distribution system, access to the second user to the digital content responsive to the determination.

2. The method of claim 1, wherein (a) further comprises specifying, by the publisher via the content distribution system, identification of a specific user to receive access to the digital content via the content distribution system and a predetermined number of devices for the specific user.

3. The method of claim 2, wherein (a) further comprises specifying, by the publisher via the content distribution system, a geographical limitation on a location at which devices of the predetermined number of devices are authorized to access the digital content.

4. The method of claim 2, wherein (a) further comprises specifying, by the publisher via the content distribution system, a dynamic expiration of when devices of the predetermined number of devices are authorized to access the digital content, the dynamic expiration comprising one of a given number of days or a scheduled date upon which the digital content is no longer accessible without further action by the publisher.

5. The method of claim 1, wherein (b) further comprises receiving, by the content distribution system, the first request responsive to the first user receiving a communication that the digital content is available at the content distribution system.

6. The method of claim 1, wherein (c) further comprises identifying, by the content distribution system, that a device associated with the first user has not been assigned a unique device identifier generated by the content distribution system.

7. The method of claim 1, wherein (d) further comprises identifying, by the content distribution system, that a number of unique device identifiers generated for the digital content has reached a same number as the predetermined number of devices.

8. The method of claim 7, wherein receiving the second request to share the digital content with the second user comprises denying, by the content distribution system, the second user access to the digital content responsive to identifying that the number of unique device identifiers generated for the digital content has reached a same number as the predetermined number of devices.

9. The method of claim 1, further comprising:
receiving, by the content distribution system, a third request of a device to access the digital content, the device previously activated by the content distribution system as one of a predetermined number of devices authorized to access the digital content; and
providing, by the content distribution system, access to the device to the digital content.

10. The method of claim 1, further comprising:
receiving, by the content distribution system, a third request of a device to access the digital content;
determining by the content distribution system, that one of a geographical location of the device or time of access by the device does not meet the sharing policy specified by the publisher for the digital content; and
restricting the device from accessing the digital content responsive to the determination.

11. A system for sharing digital content via the content distribution system while maintaining control over access to the digital content, the system comprising:
a content distribution system including a memory and one or more processors, the content distribution system including
a policy engine configured to receive configuration of a sharing policy for sharing digital content;
a digital content manager configured to
receive a first request of a first user to access the digital content;
provide, to the first user, access to the digital content;
receive a second request of the first user to share the digital content with a second user;
determine, based on the sharing policy, that the first user is authorized to share the digital content with the second user; and
provide access to the second user to the digital content responsive to the determination.

12. The system of claim 11, wherein the configuration specifies an identity of a specific user to receive access to the digital content via the content distribution system and a predetermined number of devices for the specific user.

13. The system of claim 12, wherein the configuration specifies a geographical limitation on a location at which devices of the predetermined number of devices is authorized to access the digital content.

14. The system of claim 12, wherein the configuration specifies a dynamic expiration of when devices of the predetermined number of devices are authorized to access the digital content, the dynamic expiration comprising one of a given number of days or a scheduled date upon which the digital content is no longer accessible without further action by the publisher.

15. The system of claim 11, wherein to receive the first request of the first user to access the digital content, the digital content manager is further configured to receive the first request responsive to the first user receiving a communication that the digital content is available at the content distribution system.

16. The system of claim 11, wherein to provide, to the first user, access to the digital content, the digital content manager is further configured to identify that a device associated with the first user has not been assigned a unique device identifier generated by the content distribution system.

17. The system of claim 11, wherein to receive the second request to share the digital content with the second user, the digital content manager is further configured to identify that a number of unique device identifiers generated for the digital content has reached a same number as the predetermined number of devices.

18. The system of claim 17, wherein to receive the second request to share the digital content with the second user, the digital content manager is further configured to deny the second user access to the digital content responsive to identifying that the number of unique device identifiers generated for the digital content has reached a same number as the predetermined number of devices.

19. The system of claim 11, wherein the digital content manager is further configured to:
receive a third request of a second device to access the digital content, the device previously activated by the content distribution system as one of a predetermined number of devices authorized to access the digital content; and
provide access to the device to the digital content to the second device.

20. The system of claim 1, wherein the digital content manager is further configured to:
receive a third request of a device to access the digital content;
determine that one of a geographical location of the device or time of access by the device does not meet the sharing policy specified by the publisher for the digital content; and
restrict the device from accessing the digital content.
